(19) United States
(12) Patent Application Publication
(10) Pub. No.: US 2019/0285773 A1
(43) Pub. Date: Sep. 19, 2019

(54) LENS FOR SPECTACLES, SPECTACLES, PROTECTIVE SHEET, AND DISPLAY

(71) Applicant: FUJIFILM CORPORATION, Tokyo (JP)

(72) Inventor: Takashi KATOU, Shizuoka (JP)

(21) Appl. No.: 16/423,159

(22) Filed: May 28, 2019

Related U.S. Application Data
(63) Continuation of application No. PCT/JP2017/039816, filed on Nov. 2, 2017.

(30) Foreign Application Priority Data
Dec. 27, 2016 (JP) 2016-253855
Aug. 25, 2017 (JP) 2017-162720

(51) Int. Cl. G02B 1/04; G02B 5/20; C08K 5/3492; C08K 5/3475; C08L 75/04; C08L 81/02

(52) U.S. Cl. CPC G02B 1/041; G02B 5/20; C08K 5/3492; G02C 7/02; C08L 75/04; C08L 81/02; C08K 5/3475

(57) ABSTRACT

A lens for spectacles containing a resin and a compound represented by Formula (1), spectacles, a protective sheet, and a display.

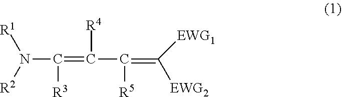

In Formula (1), EWG₁ and EWG₂ each independently represent a group having a Hammett's substituent constant σp value of 0.2 or more. R¹ and R² each independently represent an alkyl group, an aryl group, or a heteroaryl group. R³, R⁴, and R⁵ each independently represent a hydrogen atom or a substituent.

### CROSS-REFERENCE TO RELATED APPLICATIONS

This application is a continuation application of International Application No. PCT/JP2017/039816, filed Nov. 2, 2017, which is incorporated herein by reference. Further, this application claims priority from Japanese Patent Application No. 2016-253855, filed Dec. 27, 2016, and Japanese Patent Application No. 2017-162720, filed Aug. 25, 2017, which are incorporated herein by reference.

### BACKGROUND OF THE INVENTION

### 1. Field of the Invention

The present disclosure relates to a lens for spectacles, spectacles, a protective sheet, and a display.

### 2. Description of the Related Art

In the related art, as an image display device such as a cathode ray tube display device, a plasma display, an electroluminescent display, fluorescence display, a field emission display, and a liquid crystal display (LCD), and various displays such as a smart phone with a touch panel or a tablet terminal, a protective sheet including a resin is provided on a surface of an image display portion in order to prevent scratches on an image display surface.

Meanwhile, in a case where a device comprising a display of an image display device, a compact terminal with a touch panel, or the like is used, the screen of the display comprising a light source is visually observed. Blue light emitted from the display of these devices is known to be a factor causing eye strain.

Therefore, in recent years, there is an attempt to cause a spectacle lens to absorb blue light (particularly, light in a wavelength range of 380 nm to 400 nm) such that the influence of blue light on the eye is reduced.

For example, as a lens for spectacles which can absorb blue light, a lens for spectacles including a benzotriazole-based ultraviolet absorbing agent has been proposed (see, for example, JP2004-315556A and JP2010-084006A).

In addition, there is an attempt to cause a protective sheet to absorb blue light having a wavelength of 400 nm to 500 nm such that an influence of blue light on the eye is reduced.

For example, as a protective sheet for displays such as compact terminals, a protective sheet including an ultraviolet absorbing agent such as perylene, naphthalimide, or benzotriazole has been proposed (for example, JP5459446B).

### SUMMARY OF THE INVENTION

However, since the benzotriazole-based ultraviolet absorbing agent has poor compatibility with a resin that is the material of a plastic lens, the ultraviolet absorbing agent can be precipitated in a case of being applied to a lens for spectacles. Since a plastic lens in which the ultraviolet absorbing agent is precipitated has a high haze and a low transparency, there is a tendency in that the plastic lens is less suitable as a lens for spectacles. In the lens for spectacles including a benzotriazole-based ultraviolet absorbing agent, the blue light having the wavelength of about 400 nm cannot sufficiently be shielded.

Generally, with respect to a lens for spectacles, it is required that the change of the tint is hardly recognized in a case where an object is viewed through the lens.

An ultraviolet absorbing agent such as perylene, naphthalimide, and benzotriazole has poor compatibility with the resin that is the material of the protective sheet and thus may be precipitated in a case of being applied to a protective sheet. The protective sheet in which the ultraviolet absorbing agent is precipitated has high haze and low transparency, and thus there is a tendency in that the protective sheet is less suitable particularly as a protective sheet used for displays such as compact terminals.

Also with respect to the protective sheet used for a display, generally, it is required that the change of the tint is hardly recognized in a case where a display is viewed through the sheet.

One embodiment of the present invention relates to providing a lens for spectacles that can shield blue light in a wavelength range of at least 380 nm to 400 nm and in which the change of the tint is hardly recognized in a case where an object is viewed through a lens.

Another embodiment of the present invention relates to providing spectacles comprising the lens for spectacles.

Still another embodiment of the present invention relates to providing a protective sheet that can shield blue light in a wavelength range of at least 380 nm to 400 nm and in which the change of the tint is hardly recognized in a case where an object is viewed through the sheet.

Still another embodiment of the present invention relates to providing a display comprising the protective sheet.

Means for solving the above problems include the following aspects.

<1> A lens for spectacles comprising: a resin; and a compound represented by Formula (1),

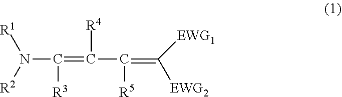

in Formula (1), EWG₁ and EWG₂ each independently represent a group having a Hammett's substituent constant σp value of 0.2 or more, R¹ and R² each independently represent an alkyl group, an aryl group, or a heteroaryl group, and R³, R⁴, and R⁵ each independently represent a hydrogen atom or a substituent.

<2> The lens for spectacles according to <1>, in which in Formula (1), EWG₁ and EWG₂ each independently represent COOR⁶, SO₂R⁷, CN, or COR⁸, and R⁶, R⁷, and R⁸ each independently represent an alkyl group, an aryl group, or a heteroaryl group.

<3> The lens for spectacles according to <1> or <2>, in which, in Formula (1), EWG₁ and EWG₂ each independently represent COOR⁶, SO₂R⁷, CN, or COR⁸, R⁷ represents an aryl group, and R⁶ and R⁸ each independently represent an alkyl group.

<4> The lens for spectacles according to any one of <1> to <3>, in which, in Formula (1), any one of EWG₁ or EWG₂ represents COOR⁶, and the other represents SO₂R⁷ or CN, R⁶ represents an alkyl group, and R⁷ represents an aryl group.

<5> The lens for spectacles according to any one of <1> to <4>, in which, in Formula (1), Rⁱ and R² each independently represent an alkyl group.

<6> The lens for spectacles according to any one of <1> to <5>, in which, in Formula (1), R³, R⁴, and R⁵ represent a hydrogen atom.

<7> The lens for spectacles according to any one of <1> to <6>, in which the resin is at least one resin selected from the group consisting of a urethane resin or a polycarbonate resin.

<8> The lens for spectacles according to <7>, in which the urethane resin is a thiourethane resin.

<9> The lens for spectacles according to any one of <1> to <8>, in which a refractive index of the resin is higher than 1.65.

<10> The lens for spectacles according to any one of <1> to <9>, in which the resin is an episulfide resin.

<11> The lens for spectacles according to any one of <1> to <10>, further comprising: at least one ultraviolet absorbing agent selected from a triazine-based ultraviolet absorbing agent or a benzotriazole-based ultraviolet absorbing agent.

<12> Spectacles comprising: the lens for spectacles according to any one of <1> to <11>.

<13> A protective sheet comprising: a support; and a layer that is disposed on at least one surface of the support and contains a compound represented by Formula (1),

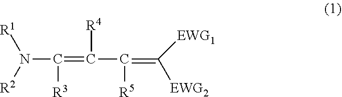

in Formula (1), EWG₁ and EWG₂ each independently represent a group having a Hammett's substituent constant σp value of 0.2 or more, R¹ and R² each independently represent an alkyl group, an aryl group, or a heteroaryl group, and R³, R⁴, and R⁵ each independently represent a hydrogen atom or a substituent.

<14> The protective sheet according to <13>, in which, in Formula (1), EWG₁ and EWG₂ each independently represent COOR⁶, SO₂R⁷, CN, or COR⁸, and R⁶, R⁷, and R⁸ each independently represent an alkyl group, an aryl group, or a heteroaryl group.

<15> The protective sheet according to <13> or <14>, in which, in Formula (1), EWG₁ and EWG₂ each independently represent COOR⁶, SO₂R⁷, CN, or COR⁸, R⁷ represents an aryl group, and R⁶ and R⁸ each independently represent an alkyl group.

<16> The protective sheet according to any one of <13> to <15>, in which, in Formula (1), any one of EWG₁ or EWG₂ represents COOR⁶, and the other represents SO₂R⁷ or CN, R⁶ represents an alkyl group, and R⁷ represents an aryl group.

<17> The protective sheet according to any one of <13> to <16>, in which, in Formula (1), R¹ and R² each independently represent an alkyl group.

<18> The protective sheet according to any one of <13> to <17>, in which, in Formula (1), R³, R⁴, and R⁵ represent a hydrogen atom.

<19> A display comprising: the protective sheet according to any one of <13> to <18>.

According to one embodiment of the present invention, there is provided a lens for spectacles that can shield blue light in a wavelength range of at least 380 nm to 400 nm and in which the change of the tint is hardly recognized in a case where an object is viewed through a lens.

According to another embodiment of the present invention, there is provided spectacles comprising the lens for spectacles.

According to still another embodiment of the present invention, there is provided a protective sheet that can shield blue light in a wavelength range of at least 380 nm to 400 nm and in which the change of the tint is hardly recognized in a case where an object is viewed through the sheet.

According to still another embodiment of the present invention, there is provided a display comprising the protective sheet.

### DESCRIPTION OF THE PREFERRED EMBODIMENTS

Hereinafter, examples of the lens for spectacles, spectacles, the protective sheet, and the display to which the present invention is applied are described. However, the present invention is not limited to the following embodiments at all, and modifications can be made as appropriate within the scope of the object of the embodiments of the present invention.

In the present disclosure, a numerical range indicated by using “to” means a range including numerical values described before and after “to” as the minimum value and the maximum value, respectively.

In the numerical ranges described in a stepwise manner in the present disclosure, an upper limit value or a lower limit value described in a certain numerical range may be replaced with an upper limit value or a lower limit value in another numerical range described in a stepwise manner. In the numerical ranges described in the present disclosure, the upper limit value or the lower limit value in a certain numerical range may be replaced with values described in the examples.

In the present disclosure, a combination of two or more preferred aspects is a more preferable aspect.

In the present disclosure, in a case where a plurality of substances corresponding to each component are present, a concentration or a content of each component means a total concentration or a total content of the plurality of substances, unless described otherwise.

According to the present disclosure, the expression “a change of tint is hardly recognized in a case where an object is viewed through a lens (or a sheet)” is referred to as “color reproducibility is satisfactory”.

In the present disclosure, the “shielding of the blue light” means not only the case where the blue light is completely shielded but also the case where at least a part of the blue light via a lens for spectacles (or protective sheet) is shielded so as to reduce the transmittance of the blue light.

### Lens for Spectacles

The lens for spectacles according to the present disclosure contains a resin and a compound (hereinafter, referred to as a “specific compound”) represented by Formula (1).

The lens for spectacles according to the present disclosure can shield blue light in a wavelength range of at least 380 nm to 400 nm, and a change of tint is hardly recognized in a case where an object is viewed through the lens.

Although the reason that the lens for spectacles according to the present disclosure can exhibit such an effect is not clear, the present inventors assume as follows.

Blue light in the wavelength range of 380 nm to 400 nm can be shielded to some extent by an ultraviolet absorbing agent having maximum absorption in the wavelength range of 380 nm to 400 nm. However, in a case where general ultraviolet absorbing agents are applied to plastic lenses formed of resins, the ultraviolet absorbing agents are easily precipitated to increase the haze. Therefore, there is a tendency in that plastic lenses including general ultraviolet absorbing agents are less suitable as lenses for spectacles.

On the other hand, the specific compound included in the lens for spectacles of the present disclosure has the maximum absorption in the wavelength range of 380 nm to 400 nm, and has good compatibility with a resin used for the plastic lens for spectacles. Therefore, the lens for spectacles of the present disclosure which contains the specific compound has the suitability as a lens for spectacles having a low haze and excellent transparency and can shield blue light in a wavelength range of 380 nm to 400 nm.

The specific compound included in the lens for spectacles of the present disclosure has a sharp peak at the maximum absorption wavelength in the absorption spectrum, has extremely low absorptivity of light at a wavelength on a shorter wavelength side or a longer wavelength side than the maximum absorption wavelength, and has satisfactory skirting of the absorption spectrum, and thus in a case where the specific compound is applied to a lens for spectacles, the lens for spectacles does not have a yellowish tint. It is considered that, with respect to the lens for spectacles according to the present disclosure which contains the specific compound, a change of tint is hardly recognized in a case where an object is viewed through the lens.

With respect to the lens for spectacles of the present disclosure, lenses for spectacles disclosed in JP2004-315556A and JP2010-084006A include a benzotriazole-based ultraviolet absorbing agent. It is considered that the benzotriazole-based ultraviolet absorbing agent cannot sufficiently shield blue light having a wavelength of about 400 nm because the molar absorption coefficient at a wavelength of about 400 nm is not high.

Since the benzotriazole-based ultraviolet absorbing agent included in the lenses for spectacles disclosed in JP2004-315556A and JP2010-084006A can absorb light having a wavelength of around 450 nm, there is a tendency in that the lens for spectacles easily become yellowish. Accordingly, it is considered that with respect to the lenses for spectacles disclosed in JP2004-315556A and JP2010-084006A, a change of tint is easily recognized in a case where an object is viewed through the lenses.

Since the benzotriazole-based ultraviolet absorbing agent included in the lens for spectacles disclosed in JP2004-315556A and JP2010-084006A do not have satisfactory compatibility with the resin that is the material of the plastic lens, in a case of being applied to the lens for spectacles, the ultraviolet absorbing agent may be precipitated. It is considered that, since the lenses for spectacles disclosed in JP2004-315556A and JP2010-084006A have the high haze and low transparency, the lenses are less suitable as a lens for spectacles.

However, the above assumption does not construe the effect of the present invention in a limited manner, and is described as an example.

Hereinafter, before the respective components in the lens for spectacles of the present disclosure are described, a “substituent” (that is, substituent represented by R³, R⁴, and R⁵ in Formula (1)) of the present disclosure is specifically described.

The “substituent” of the present disclosure is preferably an alkyl group, an alkenyl group, an alkynyl group, an aryl group, or an aralkyl group.

The alkyl group may be an unsubstituted alkyl group or a substituted alkyl group.

The “substituted alkyl group” means an alkyl group in which a hydrogen atom of the alkyl group is substituted with another substituent. In the same manner, the substituted alkenyl group, the substituted alkynyl group, and the substituted aralkyl group mean that a hydrogen atom of each group is substituted with another substituent. The “other substituents” are described below.

The alkyl group may have any of linear, branched and cyclic molecular structures.

The number of carbon atoms of the alkyl group is preferably 1 to 20, more preferably 1 to 18, even more preferably 1 to 10, and particularly preferably 1 to 5. The number of carbon atoms in this case does not include the number of carbon atoms of the substituent in a case where the alkyl group further has a substituent.

The alkenyl group may be an unsubstituted alkenyl group or a substituted alkenyl group.

The alkenyl group may have any of linear, branched or cyclic molecular structure.

The number of carbon atoms of the alkenyl group is preferably 2 to 20 and more preferably 2 to 18. The number of carbon atoms in this case does not include the number of carbon atoms of the substituent in a case where the alkenyl group further has a substituent.

The alkynyl group may be an unsubstituted alkynyl group or a substituted alkynyl group.

The alkynyl group may have any of linear, branched or cyclic molecular structure.

The number of carbon atoms of the alkynyl group is preferably 2 to 20 and more preferably 2 to 18. The number of carbon atoms in this case does not include the number of carbon atoms of the substituent in a case where the alkynyl group further has a substituent.

The aryl group may be an unsubstituted aryl group or a substituted aryl group.

The number of carbon atoms of the aryl group is preferably 6 to 20 and more preferably 6 to 10. The number of carbon atoms in this case does not include the number of carbon atoms of the substituent in a case where the aryl group further has a substituent.

The aralkyl group may be an unsubstituted aralkyl group or a substituted aralkyl group.

The alkyl moiety of the aralkyl group is the same as the alkyl group which is the substituent described above.

The aryl moiety of the aralkyl group may be fused with an aliphatic ring, another aromatic ring, or a heterocyclic ring.

The aryl moiety of the aralkyl group is the same as the aryl group which is the substituent described above.

Substituents (that is, other substituents) included in the substituted alkyl group, the substituted alkenyl group, the substituted alkynyl group, the substituted aryl group, and the substituted aralkyl group may be optionally selected from the following substituent group.

Substituent group: a halogen atom, an alkyl group, an alkenyl group, an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imide group, a phosphino group, a phosphinyl group, a phosphinyloxy group, a phosphinylamino group, and a silyl group.

As details of the examples of the substituent included in the substituted alkyl group, the substituted alkenyl group, the substituted alkynyl group, and the substituted aralkyl group, the description in JP2007-262165A can be referred to.

### Compound Represented by Formula (1)

The lens for spectacles of the present disclosure contains a compound (that is, a specific compound) represented by Formula (1). The specific compound is a compound having an ultraviolet absorbing ability capable of absorbing blue light in a wavelength range of 380 nm to 400 nm.

The lens for spectacles of the present disclosure can shield blue light in a wavelength range of at least 380 nm to 400 nm by containing the specific compound, and thus exhibits an effect of causing a change of tint to be hardly recognized in a case where an object is viewed through the lens. In the lens for spectacles of the present disclosure containing the specific compound, a haze hardly occurs, light resistance is excellent, yellowishness hardly occurs, and the suitability as a lens used for spectacles is sufficient.

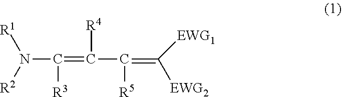

In Formula (1), EWG₁ and EWG₂ each independently represent a group having the Hammett's substituent constant σp value of 0.2 or more. R¹ and R² each independently represents an alkyl group, an aryl group, or a heteroaryl group. R³, R⁴, and R⁵ each independently represent a hydrogen atom or a substituent.

In Formula (1), EWG₁ and EWG₂ each independently represent a group having the Hammett's substituent constant σp value of 0.2 or more, preferably represent a group of 0.30 or more, and more preferably represent a group of 0.40 or more.

The upper limit of the Hammett's substituent constant σp value of the group represented by EWG₁ and EWG₂ is not particularly limited, and, for example, is preferably 1.0 or less.

The “Hammett's substituent constant” according to the present disclosure is a constant specific to a substituent in a relational expression established as the Hammett rule. The positive Hammett's substituent constant σ value indicates that the substituent is electron withdrawing.

The Hammett rule is a rule of thumb proposed by L. P. Hammett in 1935 to quantitatively discuss the influence of substituents on the reaction or equilibrium of a benzene derivative, but is widely accepted today. Substituent constants determined by the Hammett rule include σp values and σm values. These values are disclosed in many general documents, for example, “Lange's Handbook of Chemistry” 12th Edition, edited by J. A. Dean, 1979 (Mc Graw-Hill) and “Special Issue of Field of Chemistry”, No. 122, pages 96 to 103, 1979 (Nankodo Co., Ltd.).

In Formula (1), EWG₁ and EWG₂ are regulated by the Hammett's substituent constant σp value, the present invention is not limited to substituents having existing values disclosed in these documents, and even in a case where a value is not disclosed in the documents, as long as the value measured based on the Hammett rule is 0.2 or more, the value is included in the present invention.

Examples of the group having the Hammett's substituent constant σp value of 0.2 or more include a cyano group (0.66), a carboxy group (—COOH: 0.45), an alkoxycarbonyl group (—COOMe: 0.45, —COOC₈H₁₇: 0.44, —COOC₉H₁₉: 0.44, —COOC₁₃H₂₇: 0.44), an aryloxycarbonyl group (—COOPh: 0.44), a carbamoyl group (—CONH₂: 0.36), an acetyl group (—COMe: 0.50), an arylcarbonyl group (—COPh: 0.43), an alkylsulfonyl group (—SO₂Me: 0.72), and an arylsulfonyl groups (—SO₂Ph: 0.68). In parentheses, representative substituents and σp values thereof are extracted from Chem. Rev., 1991, vol. 91, pages 165 to 195. A sulfamoyl group, a sulfinyl group, a heterocyclic group and the like are also included in a group having the Hammett's substituent constant σp value of 0.2 or more.

In the present disclosure, “Me” represents a methyl group, and “Ph” represents a phenyl group.

In Formula (1), since blue light in the wavelength range of 380 nm to 400 nm can be shielded in a more satisfactory manner and a change of tint is hardly recognized in a case where an object is viewed through the lens, it is preferable that EWG₁ and EWG₂ each independently represent COOR⁶, SO₂R⁷, CN, or COR^{S}, and R⁶, R⁷, and R⁸ each independently represent an alkyl group, an aryl group, or a heteroaryl group.

The alkyl group represented by R⁶, R⁷, and R⁸ may be an unsubstituted alkyl group or a substituted alkyl group.

Specific examples of EWG₁ or EWG₂ include an alkoxycarbonyl group, an arylcarbonyl group, an aryloxycarbonyl group, an alkylsulfonyl group, an arylsulfonyl group, a cyano group, an acyl group, and an aryloxycarbonyl group.

The number of carbon atoms of the alkoxycarbonyl group is not particularly limited, and for example, is preferably 2 to 20 and more preferably 2 to 9. Specific examples of the alkoxycarbonyl group having 2 to 20 carbon atoms include a methoxycarbonyl group, an ethoxycarbonyl group, a t-butoxycarbonyl group, an octyloxycarbonyl group, a nonyloxycarbonyl group, a tridecyloxycarbonyl group, and a benzyloxycarbonyl group.

The carbon number of the arylcarbonyl group is not particularly limited, and, for example, is preferably 7 to 20 and more preferably 7 to 15. Specific examples of the arylcarbonyl group having 7 to 20 carbon atoms include a phenylcarbonyl group.

The carbon number of the alkylsulfonyl group is not particularly limited, and, for example, is preferably 6 to 20 and more preferably 6 to 15. Specific examples of the alkylsulfonyl group having 6 to 20 carbon atoms include a hexylsulfonyl group, an octylsulfonyl group, and a dodecylsulfonyl group.

The number of carbon atoms of the arylsulfonyl group is not particularly limited, and is preferably, for example, 6 to 15. Examples of the arylsulfonyl group having 6 to 15 carbon atoms include a phenylsulfonyl group, a benzenesulfonyl group, a p-toluenesulfonyl group, a p-chlorobenzenesulfonyl group, and a naphthalenesulfonyl group.

The number of carbon atoms of the acyl group is not particularly limited, and, for example, is preferably 2 to 20 and more preferably 2 to 5. Specific examples of the acyl group having 2 to 20 carbon atoms include an acetyl group and a propionyl group.

The number of carbon atoms of the aryloxycarbonyl group is not particularly limited, and, for example, is preferably 7 to 20 and more preferably 7 to 15. Specific examples of the aryloxycarbonyl group having 7 to 20 carbon atoms include a phenoxycarbonyl group and a p-nitrophenoxycarbonyl group.

It is more preferable that, in Formula (1), EWG₁ and EWG₂ can shield blue light in the wavelength range of 380 nm to 400 nm in a more satisfactory manner and each independently represent COOR⁶, SO₂R⁷, CN, or COR⁸, R⁷ represents an aryl group, and R⁶ and R⁸ each independently represent an alkyl group, in view of causing a change of tint to be hardly recognized in a case where an object is viewed through a lens.

In Formula (1), as the particularly preferable aspects of EWG₁ and EWG₂, any one of EWG₁ or EWG₂ represents COOR⁶, and the other represents SO₂R⁷ or CN, and R⁶ represents an alkyl group and R⁷ represents an aryl group.

According to such an aspect, it is possible to realize a lens for spectacles having remarkably excellent shielding properties of blue light (particularly, blue light having wavelength of 400 nm) in the wavelength range of 380 nm to 400 nm and having a change of tint that is hardly recognized in a case where an object is viewed through the lens.

In Formula (1), R¹ and R² each independently represent an alkyl group, an aryl group, or a heteroaryl group, preferably represent an alkyl group or an aryl group, and more preferably represent an alkyl group.

The alkyl group represented by R¹ and R² may be an unsubstituted alkyl group or a substituted alkyl group. The alkyl group represented by R¹ and R² may have any of linear, branched and cyclic molecular structures.

The number of carbon atoms of the alkyl group represented by R¹ and R² is not particularly limited, and, for example, is preferably 1 to 20, more preferably 1 to 15, and even more preferably 1 to 10.

Any substituents having a substituted alkyl group can be selected, for example, from the substituent groups described above.

The aryl group represented by R¹ and R² may be an unsubstituted aryl group or a substituted aryl group. The aryl group represented by R¹ and R² may be fused with an aliphatic ring, another aromatic ring, or a heterocyclic ring.

The number of carbon atoms of the aryl group represented by R¹ and R² is not particularly limited, and, for example, is preferably 6 to 30, more preferably 6 to 20, and even more preferably 6 to 15.

The aryl group represented by R¹ and R² is preferably a phenyl group or a naphthyl group and particularly preferably a phenyl group.

The aryl moiety of the substituted aryl group is the same as the aryl group described above.

Any substituents having a substituted aryl group can be selected, for example, from the substituent groups described above.

The heteroaryl group represented by R¹ and R² may be an unsubstituted heteroaryl group or a substituted heteroaryl group. The heteroaryl group represented by R¹ and R² may be fused with an aliphatic ring, an aromatic ring, or another heterocyclic ring.

The heteroaryl group represented by R¹ and R² preferably contains a 5-membered or 6-membered saturated or unsaturated heterocyclic ring.

Examples of the hetero atom in the heteroaryl group represented by R¹ and R² include B, N, O, S, Se, and Te, and N, O, and S are preferable.

With respect to the heteroaryl group represented by R¹ and R², it is preferable that a carbon atom has a free valence (monovalent) (that is, the heteroaryl group is bonded to a carbon atom).

The number of carbon atoms of the heteroaryl group represented by R¹ and R² is not particularly limited, and, for example, is preferably 1 to 40, more preferably 1 to 30, and even more preferably 1 to 20.

Specific examples of the heteroaryl group include a pyrrolidine group, a morpholine group, an imidazole group, a thiazole group, a benzothiazole group, a benzoxazole group, a benzotriazole group, a benzoselenazole group, a pyridine group, a pyrimidine group, and a quinoline group.

The heteroaryl moiety of the substituted heteroaryl group is the same as the heteroaryl group described above.

Any substituents having a substituted heteroaryl group can be selected, for example, from the substituent groups described above.

In Formula (1), R³, R⁴, and R⁵ each independently represent a hydrogen atom or a substituent, preferably represent a hydrogen atom, an alkyl group having 1 to 10 carbon atoms, or an aryl group having 6 to 10 carbon atoms, and more preferably represent a hydrogen atom or an alkyl group having 1 to 5 carbon atoms, and it is particularly preferable that all of R³, R⁴, and R⁵ represent hydrogen atoms.

Specific examples of the compound (that is, the specific compound) represented by Formula (1) include example compounds (I-1) to (I-20) and (II-1) to (II-10). Here, the compound represented by Formula (1) is not limited to these example compounds.

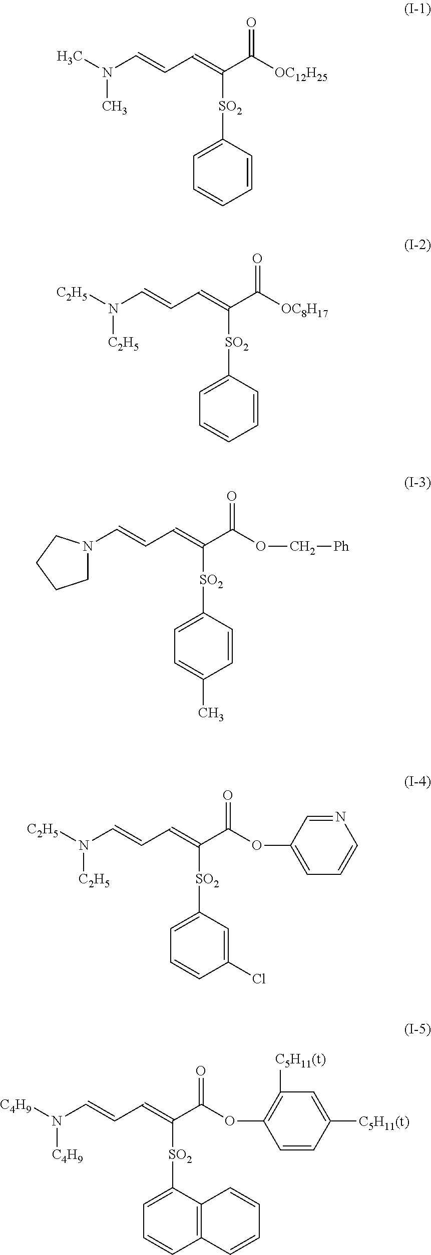

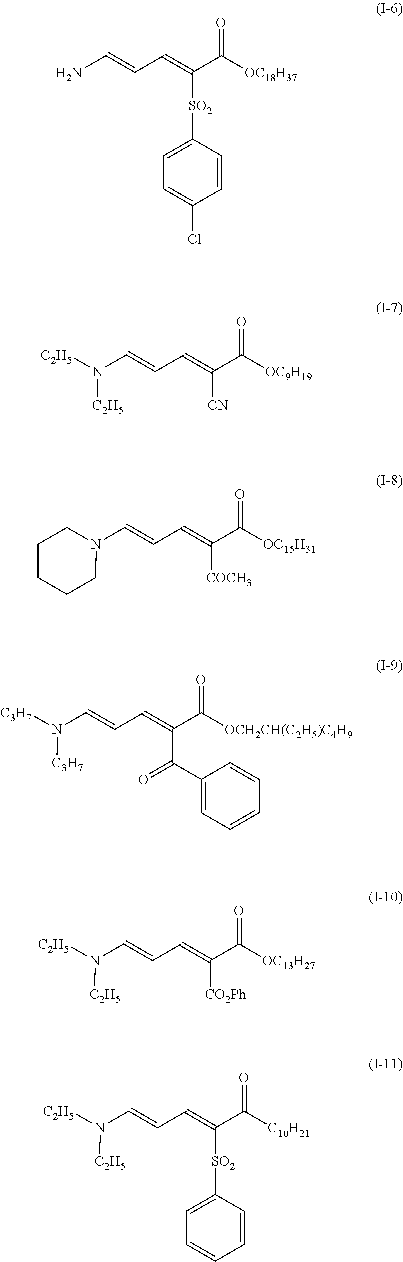

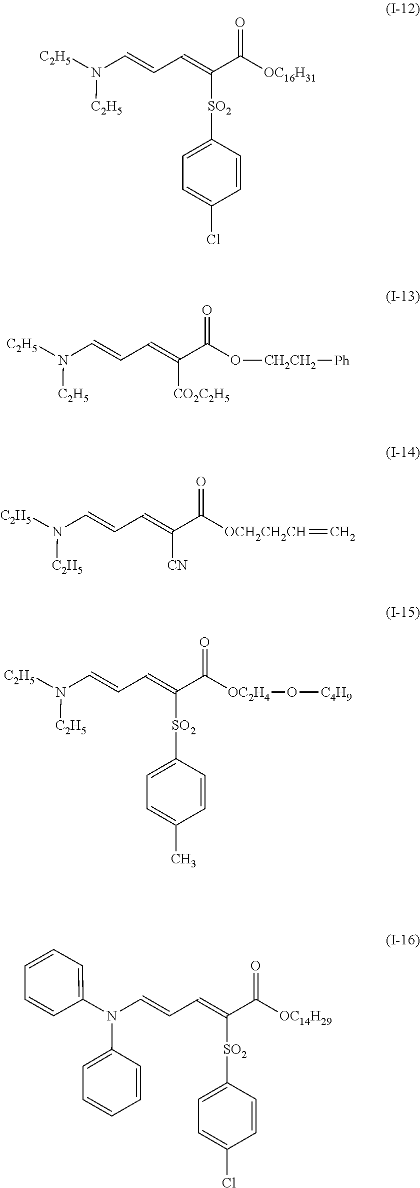

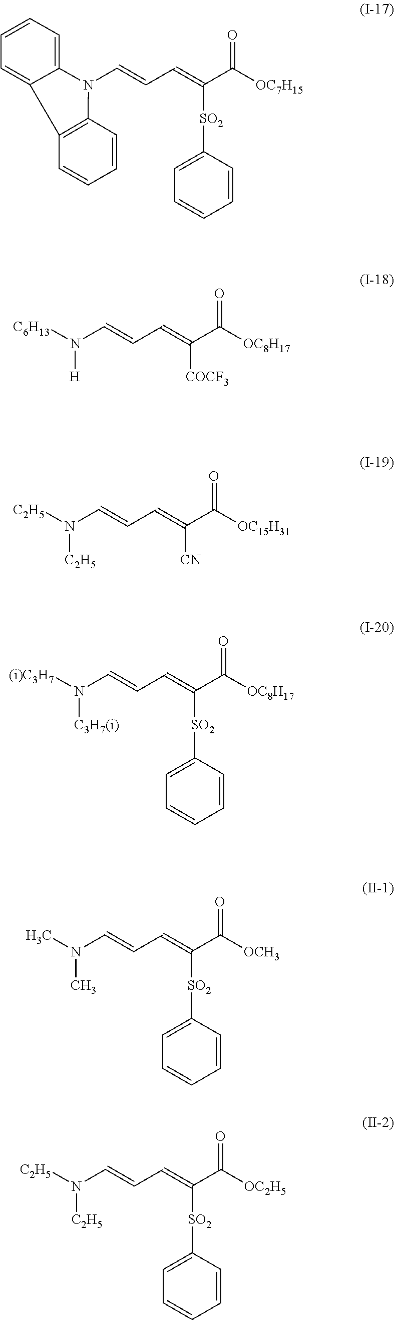

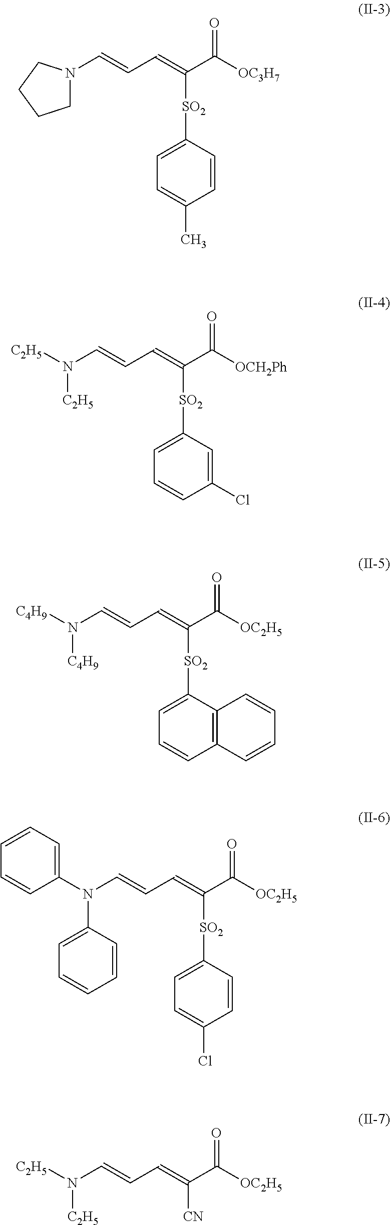

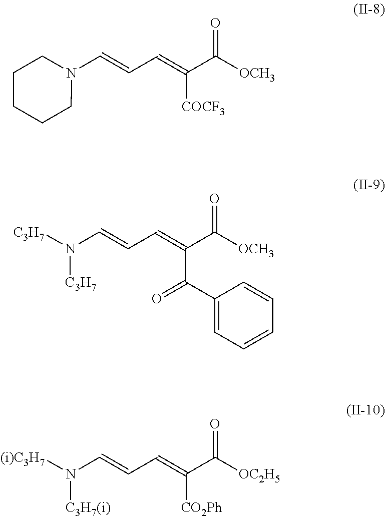

The lens for spectacles of the present disclosure may contain only one kind of the specific compound or may contain two or more kinds thereof.

The content ratio of the specific compound in the lens for spectacles according to the present disclosure is not particularly limited, and, for example, is preferably 0.01 mass % to 1.0 mass %, more preferably 0.01 mass % to 0.5 mass %, and even more preferably 0.01 mass % to 0.1 mass % with respect to the total mass of the resin.

In a case where the content ratio of the specific compound in the lens for spectacles of the present disclosure is in the above range, the compatibility with the resin is satisfactory, and thus the specific compound is hardly precipitated, and a haze hardly occurs. Since the specific compound has a high molar absorption coefficient in the wavelength range of 380 nm to 400 nm (particularly 400 nm), even in a case where the content ratio in the lens for spectacles of the present disclosure is within the above range, the blue light in the above wavelength range can be shielded in a satisfactory manner.

### Resin

The lens for spectacles of the present disclosure contains a resin.

The resin is not particularly limited, as long as the resin is a resin that satisfies physical properties such as transparency, a refractive index, workability, and hardness after curing, which are required for the lens for spectacles. The resin may be a thermoplastic resin (for example, a polycarbonate resin) or a thermosetting resin (for example, a urethane resin).

In view of high refractive index, the resin is preferably at least one resin selected from the group consisting of a urethane resin, an episulfide resin, and a polycarbonate resin and more preferably at least one resin selected from a urethane resin or an episulfide resin.

The urethane resin is particularly preferably a thiourethane resin.

The thiourethane resin and the episulfide resin are widely used as materials for the lens for spectacles, but are resins that have poor the compatibility with an ultraviolet absorbing agent (for example, a benzotriazole-based ultraviolet absorbing agent) used in the lens for spectacles in the related art and, particularly, in which the ultraviolet absorbing agent is easily precipitated.

Even in a case where the lens for spectacles of the present disclosure contains a thiourethane resin and/or an episulfide resin as the resin, the precipitation of the ultraviolet absorbing agent is suppressed, and thus the change of tint is hardly recognized in a case where an object is viewed through the lens.

In the resin of the lens for spectacles of the present disclosure, the refractive index may be higher than 1.65.

For details of the thiourethane resin and the episulfide resin suitable as the resin of the lens for spectacles of the present disclosure, the disclosure of JP1996-003267A (JP-H08-003267A), JP1999-158229A (JP-H11-158229A), JP2009-256692A, JP2007-238952A, JP2009-074624A, JP2015-212395A, and JP2016-084381A.

As the resin, a commercially available resin can be used.

Examples of commercially available products of the resins include PANLITE (registered trademark) L-1250WP (trade name, aromatic polycarbonate resin powder, Teijin Limited), PANLITE (registered trademark) SP-1516 (trade name, Teijin Limited) IUPIZETA (registered trademark) EP-5000 (trade name, Mitsubishi Gas Chemical Company Inc.), and IUPIZETA (registered trademark) EP-4000 (trade name, Mitsubishi Gas Chemical Company Inc.).

The resin may be a resin formed using a precursor monomer of a commercially available resin.

Examples of commercially available products of the precursor monomer of the resin include MR-7 (registered trademark) [refractive index: 1.67], MR-8 (registered trademark) [refractive index: 1.60] MR-10 (registered trademark) [refractive index: 1.67], and MR-174 (registered trademark) [refractive index: 1.74] (above are trade names, Mitsui Chemicals, Inc.) which are precursor monomers of the thiourethane resin. Examples thereof also include LUMIPLUS (registered trademark) LPB-1102 [refractive index n=1.71] [above trade name, Mitsubishi Gas Chemical Company Inc.].

The lens for spectacles of the present disclosure may contain only one kind of the resin and may contain two or more kinds thereof.

The content ratio of the resin in the lens for spectacles according to the present disclosure is not particularly limited, for example, and is preferably 20 mass % to 99.99 mass %, more preferably 50 mass % to 99.99 mass %, and even more preferably 70 mass % to 99.99 mass % with respect to the total mass of the lens for spectacles.

In a case where the content ratio of the resin in the lens for spectacles according to the present disclosure is in the above range, it is possible to manufacture a lightweight and thin lens.

### Other Ultraviolet Absorbing Agents

The lens for spectacles of the present disclosure may contain a compound (hereinafter, referred to as “other ultraviolet absorbing agents”) having an ultraviolet absorbing ability in addition to the above specific compound.

The lens for spectacles of the present disclosure can shield blue light in a wide range of the ultraviolet region by containing other ultraviolet absorbing agents.

The other ultraviolet absorbing agents are not particularly limited, as long as the ultraviolet absorbing agent is a well-known ultraviolet absorbing agent used for the lens for spectacles.

Examples of the other ultraviolet absorbing agent include ultraviolet absorbing agents such as a triazine-based compound (that is, a triazine-based ultraviolet absorbing agent), a benzotriazole-based compound (that is, a benzotriazole-based ultraviolet absorbing agent), a benzophenone-based compound (that is, a benzophenone-based ultraviolet absorbing agent), a cyanine-based compound (that is, a cyanine-based ultraviolet absorbing agent), a dibenzoylmethane-based compound (that is, a dibenzoylmethane-based ultraviolet absorbing agent), a cinnamic acid-based compound (that is, a cinnamic acid-based ultraviolet absorbing agent), an acrylate-based compound (that is, an acrylate-based ultraviolet absorbing agent), a benzoate ester-based compound (that is, a benzoate ester-based ultraviolet absorbing agent), an oxalic acid diamide-based compound (that is, an oxalic acid diamide-based ultraviolet absorbing agent), a formamidine-based compound (that is, a formamidine-based ultraviolet absorbing agent), a benzoxazole-based compound (that is, a benzoxazole-based ultraviolet absorbing agent), a benzoxazinone-based compound (that is, a benzoxazinone-based ultraviolet absorbing agent), and a benzodithiol-based compound (that is, a benzodithiol-based ultraviolet absorbing agent). With respect to the details of these ultraviolet absorbing agents, for example, “Monthly Fine Chemicals” May 2004, pages 28 to 38, Toray Research Center, Research Division, “New Development of Functional Additives for Polymers” (Toray Research Center, 1999) pages 96 to 140, edited by Okachi Junichi, “Development of Polymer Additives And Environmental Measures” (CMC Publishing Co., Ltd., 2003) pages 54 to 64, and “Polymer Deterioration/Discoloring Mechanism and Stabilization Technology Thereof—Know-How Collection” (Technical Information Institute Co., Ltd., 2006) published by Technical Information Institute Co., Ltd. can be referred to.

Specific examples of the benzoxazole-based compound include compounds disclosed in JP4311869B, specific examples of the benzoxazinone-based compound include compounds disclosed in JP5591453B and JP5250289B, and specific examples of the benzodithiol-based compound include compounds disclosed in JP5450994B and JP5364311B.

Among these, as the other ultraviolet absorbing agent, at least one ultraviolet absorbing agent selected from the triazine-based ultraviolet absorbing agent or the benzotriazole-based ultraviolet absorbing agent is preferable.

As the other ultraviolet absorbing agents, an ultraviolet absorbing agent a maximum absorption wavelength of 350 nm or less is particularly preferable.

In the lens for spectacles of the present disclosure, by including an ultraviolet absorbing agent having a maximum absorption wavelength of 350 nm or less as the other ultraviolet absorbing agent, the change of the transmittance of the light of a wavelength of 400 nm due to the irradiation with the light of a wavelength of 350 nm or less is suppressed (that is, the light resistance of the specific compound is improved).

As the reason that the transmittance of light having a wavelength of 400 nm of the lens for spectacles including the specific compound described above is changed by irradiation of light having a wavelength of 350 nm or less, two causes are assumed: (1) the specific compound is directly decomposed by light of wavelength 400 nm, and (2) the resin is decomposed by the light having a short wavelength of 350 nm or less, and the specific compound is decomposed by the decomposition product of the resin.

Although the specific compound can sufficiently shield blue light having a wavelength of 400 nm, the specific compound transmits UV light in a wavelength range of 300 nm to 350 nm in a certain degree. Therefore, in the lens for spectacles of the present disclosure, the specific compound and the ultraviolet absorbing agent having a maximum absorption wavelength of 350 nm or less (for example, an ultraviolet absorbing agent having a property of shielding UV light in a wavelength range of 300 nm to 350 nm) are used in combination, so as to eliminate the cause of (2). Specifically, the decomposition of the resin by light having a short wavelength of 350 nm or less is suppressed by the ultraviolet absorbing agent having a maximum absorption wavelength of 350 nm or less, and thus the decomposition of the specific compound by the decomposition product of the resin is suppressed.

In a case of containing the other ultraviolet absorbing agent, the lens for spectacles of the present disclosure may contain only one kind of the other ultraviolet absorbing agent or may contain two or more kinds thereof.

In a case where the lens for spectacles of the present disclosure contains the other ultraviolet absorbing agent, the content ratio of the other ultraviolet absorbing agent in the lens for spectacles is appropriately set according to the kind of the selected ultraviolet absorbing agent.

Generally, the content ratio of the other ultraviolet absorbing agent in the lens for spectacles of the present disclosure is preferably 0.01 mass % to 1.0 mass % with respect to the total mass of the resin for one kind of the other ultraviolet absorbing agent.

In a case where the lens for spectacles of the present disclosure contains two or more kinds of the other ultraviolet absorbing agents, the total content ratio of the other ultraviolet absorbing agents in the lens for spectacles of the present disclosure is preferably 0.01 mass % to 3.0 mass % with respect to the total mass of the resin.

In a case where the total content ratio of the other ultraviolet absorbing agents in the lens for spectacles of the present disclosure is in the above range, while the occurrence of a haze and the yellowishness are suppressed, the blue light in a wide range of the ultraviolet region can be shielded in a satisfactory manner.

### Other Components

The lens for spectacles of the present disclosure may contain components (so-called, other additives) other than the components described above.

Examples of the other additives include a plasticizer, an antidegradant (for example, an antioxidant, a peroxide decomposer, a radical inhibitor, a metal deactivator, an acid scavenger, and amine), a dye, an internal release agent, and a deodorant.

### Method of Manufacturing Lens for Spectacles

A method of manufacturing the lens for spectacles of the present disclosure is not particularly limited, as long as the lens for spectacles of the present disclosure can be manufactured.

For example, in a case where the resin contained in the lens for spectacles is a thermoplastic resin, the lens for spectacles of the present disclosure can be manufactured by forming a pellet shape by using a melt extruder with a resin composition including a resin, a specific compound, if necessary, other ultraviolet absorbing agents which are optional components, and other additives, and applying a well-known forming method such as an injection molding method with the obtained resin composition in the pellet shape.

For example, in a case where the resin contained in the lens for spectacles is a thermosetting resin, the lens for spectacles of the present disclosure can be manufactured by preparing a resin composition including a monomer which is a precursor of the resin, a specific compound, a polymerization catalyst (for example, dibutyltin dichloride), and other ultraviolet absorbing agents and other additives which are optional components, if necessary, filling a mold with the obtained resin composition, and performing heating for curing.

### Spectacles

The spectacles of the present disclosure include the aforementioned lens for spectacles of the present disclosure.

That is, the spectacles of the present disclosure have a configuration in which the aforementioned lens for spectacles of the present disclosure is mounted on an appropriate spectacle frame.

According to the spectacles of the present disclosure, the blue light in the wavelength range of at least 380 nm to 400 nm can be shielded, and thus reduction of eye fatigue in a case where an operation of viewing a display of an image display device is performed for a long period of time can be expected.

According to the spectacles of the present disclosure, a change of tint is hardly recognized in a case where an object is viewed through the lens.

### Protective Sheet

The protective sheet of the present disclosure, for example, is a protective sheet having a support and a layer that is disposed on at least one surface of the support and contains a compound (that is, the specific compound) represented by Formula (1).

The protective sheet of the present disclosure is a protective sheet that is arranged on various displays of various image display devices, smart phones with a touch panel, tablet terminals, or the like, and the like and that can be suitably used for the purpose of shielding blue light emitted from the display.

The protective sheet of the present disclosure is a protective sheet that can shield the blue light in the wavelength range of at least 380 nm to 400 nm and causes a change of tint to be hardly recognized in a case where an object is viewed through the sheet.

Examples of the preferable aspect of the protective sheet of the present disclosure include an aspect (hereinafter, also referred to as a “first aspect”) having a support and a protective layer that is disposed on at least one surface of the support and contains a compound (that is, a specific compound) represented by Formula (1) and a resin and an aspect (hereinafter, also referred to as a “second aspect”) having a support and a pressure sensitive adhesive layer that is disposed on at least one surface of the support and contains a compound (that is, the specific compound) represented by Formula (1) and a pressure sensitive adhesive. In addition, an aspect in which the support contains the specific compound is exemplified.

### First Aspect

The protective sheet of the first aspect is a protective sheet having a support and a protective layer that is disposed at least one surface of the support and contains a compound (that is, a specific compound) represented by Formula (1) and a resin.

In the protective sheet of the first aspect, the protective layer may be disposed on one surface of the support and may be disposed on both surfaces of the support.

Without deteriorating the effect of the present invention, the protective sheet of the first aspect may have another layer such as an easy adhesion layer between the support and the protective layer.

Hereinafter, the protective sheet of the first aspect is specifically described.

### Support

In the protective sheet of the first aspect, the support is preferably a transparent support (hereinafter, also referred to as a “transparent support”).

The “transparent support” means an optically transparent support and specifically means a support having a total light transmittance of 90% or more. The total light transmittance of the transparent support is preferably 93% or more and more preferably 95% or more.

The total light transmittance of the support is measured with a spectrophotometer. As the spectrophotometer, for example, a spectrophotometer (model number: UV 3150) of Shimadzu Corporation can be used.

As the support, a general resin film is mentioned as a suitable example.

Examples of the resin forming a resin film used for a support include polyester such as polyethylene terephthalate (PET), polyethylene naphthalate (PEN), polybutylene terephthalate (PBT), and polycyclohexane dimethylene terephthalate (PCT), polypropylene (PP), polyethylene (PE), polyvinyl chloride (PVC), and tricellulose acetate (TAC). Among these, in view of versatility, PET is preferable.

The support can be obtained by forming the aforementioned resin into a film shape by general methods. A commercially available film may be used as a support.

The thickness of the transparent support can be appropriately selected depending on purposes of the use, such as the application, the size, and the strength of an image display device to which the protective sheet of the present disclosure is applied. Generally, the thickness of the transparent support is preferably 5 μm to 2,500 μm and more preferably 20 μm to 500 μm.

### Protective Layer

A protective layer is a layer containing the compound (that is, the specific compound) represented by Formula (1) and a resin. For example, the protective layer may be a cured product of a curable composition for forming a protective layer described below.

The protective sheet of the first aspect has a protective layer that contains the specific compound and thus can shield the blue light in the wavelength range of at least 380 nm to 400 nm, such that a change of tint is hardly recognized in a case where an object is viewed through the sheet.

### Compound Represented by Formula (1)

The protective layer contains a compound (that is, the specific compound) represented by Formula (1).

The “compound (that is, the specific compound) represented by Formula (1)” in the protective sheet of the first aspect has the same meaning as the “compound (that is, the specific compound) represented by Formula (1)” in the lens for spectacles except the following, the preferable aspect thereof is also the same, and, here, the description thereof is omitted.

The content of the specific compound in the protective layer is not particularly limited.

For example, in view of capable of shielding the blue light in the wavelength range of at least 380 nm to 400 nm in a satisfactory manner and causing a change of tint to be hardly recognized in a case where an object is viewed through the sheet, the content of the specific compound in the protective layer is preferably in the range of 0.05 mmol/m² to 10 mmol/m² and more preferably in the range of 0.1 mmol/m² to 1.0 mmol/m².

### Resin

The protective layer contains the resin.

Examples of the resin include a polymer of a polymerizable compound.

With respect to the polymerizable compound is specifically described in the section of “Curable composition for forming protective layer” below, and thus the description is omitted.

In view of film hardness of the protective layer, as the resin, for example, a (meth)acryl resin is preferable.

The protective layer may contain only one resin and two or more kinds thereof may be contained.

In view of the compatibility with the transparency and the film hardness, for example, the content ratio of the resin in the protective layer is preferably 40 mass % to 99 mass % and more preferably 60 mass % to 99 mass % with respect to the total mass of the protective layer.

### Ultraviolet Absorbing Agent

The protective layer may contain a compound (that is, the other ultraviolet absorbing agent) having ultraviolet absorbing ability in addition to the specific compound.

In addition to the specific compound, by having the protective layer containing the other ultraviolet absorbing agent, the protective sheet of the present disclosure can shield the blue light in a wide range of the ultraviolet region.

Except the following, the “other ultraviolet absorbing agent” in the protective sheet of the first aspect is the same as the “other ultraviolet absorbing agent” in the lens for spectacles, the preferable examples thereof are also the same, and thus the description thereof is omitted.

In a case of containing the other ultraviolet absorbing agent, the protective layer may contain one kind of the other ultraviolet absorbing agent and may contain two or more kinds thereof

In a case where the protective layer contains the other ultraviolet absorbing agent, the content of the other ultraviolet absorbing agent in the protective layer is appropriately set according to the kind of the ultraviolet absorbing agent.

The content of the other ultraviolet absorbing agent in the protective layer is preferably in the range of 0.005 mmol/m² to 10 mmol/m² and more preferably in the range of 0.01 mmol/m² to 1.0 mmol/m².

The thickness of the protective layer is not particularly limited.

For example, in view of the transparency and the handleability, the thickness of the protective layer is preferably in the range of 1 μm to 20 μm.

It is preferable that the protective layer is optically transparent. The expression “the protective layer is optically transparent” means that the transmittance of the protective layer in the wavelength of 400 nm is 95.0% or more. The transmittance of the protective layer in the wavelength of 400 nm is preferably 99.0% or more and more preferably 99.9% or more.

The transmittance of the protective layer in the wavelength of 400 nm is measured with a spectrophotometer. Examples of the spectrophotometer include a spectrophotometer (Model number: UV 3150) of Shimadzu Corporation.

### Method of Forming Protective Layer

Examples of the method of forming a protective layer include the following method. Here, the method of forming a protective layer in the protective sheet of the present disclosure is not limited to the following method.

The curable composition for forming a protective layer is prepared by dissolving or dispersing a specific compound, a polymerizable compound, and if necessary, a polymerization initiator, other ultraviolet absorbing agents, and various additives used in combination as desired (for example, other components described below) in an organic solvent. Next, the surface of the support is coated with the curable composition for forming a protective layer by a coating method well-known in the related art. Next, energy is applied to the coating film formed on the surface of the support to cure the coating film. The protective layer can be formed as above.

Examples of the method of applying energy to the coating film include methods such as heating and exposure, and exposure is preferable.

As a method of applying energy by exposure, light irradiation with an ultraviolet (UV) lamp, visible light, or the like can be performed.

Among these, as the method of applying energy, light irradiation with an ultraviolet (UV) lamp is preferable in view of versatility and good curing sensitivity.

The light irradiation amount is preferably in the range of 100 mW/cm² to 1 W/cm². In a case of applying ultraviolet rays in an irradiation amount in the range of 100 mW/cm² to 1 W/cm², the protective film can be suitably cured.

The coating film is preferably dried before applying an energy.

Before applying the energy, the curability of the coating film can be further improved by drying the coating film and reducing the amount of the organic solvent that can be contained in the coating film.

The method of drying the coating film is not particularly limited and, examples thereof include a method of blowing warm air, a method of causing the coating film to pass through a drying zone controlled at a predetermined temperature, and a method of performing heating with a heater provided on a transport roll.

### Curable Composition for Forming Protective Layer

In addition to the specific compound, the curable composition for forming the protective layer preferably contains, for example, a polymerizable compound, a polymerization initiator, and an organic solvent. The curable composition for forming the protective layer may further contain the other ultraviolet absorbing agent as described above. The other components described below may be contained, if necessary.

### Polymerizable Compound

The curable composition for forming a protective layer preferably contains the polymerizable compound.

The polymerizable compound can be used without particular limitation, as long as the polymerizable compound is a compound that can be polymerized and cured by applying energy.

Examples of the polymerizable compound include a compound having at least one terminal ethylenically unsaturated double bond, and a compound having two or more terminal ethylenically unsaturated double bonds is preferably selected.

For example, the polymerizable compound may have a chemical form such as a monomer, a prepolymer, that is, a dimer, a trimer, and an oligomer, a mixture thereof, or a (co)polymer thereof.

Examples of the monomer and the (co)polymer thereof include unsaturated carboxylic acid (acrylic acid, methacrylic acid, itaconic acid, crotonic acid, isocrotonic acid, and maleic acid), unsaturated carboxylic acid ester, unsaturated carboxylic acid amide, and a (co)polymer thereof, and an ester of unsaturated carboxylic acid and aliphatic a polyhydric alcohol compound and an amide of unsaturated carboxylic acid and aliphatic polyvalent amine compound, and a (co)polymer thereof are preferable.

As the polymerizable compound, an addition reaction product of unsaturated carboxylic acid ester or amide having a nucleophilic substituent such as a hydroxy group, an amino group, or a mercapto group with a monofunctional or polyfunctional isocyanate compound or an epoxy compound or a dehydration condensation reaction product with monofunctional or polyfunctional carboxylic acid can also be preferably used.

As the polymerizable compound, unsaturated carboxylic acid ester or amides having an electrophilic substituent such as an isocyanate group or an epoxy group, an addition reaction product with monofunctional or polyfunctional alcohols, amines, or thiols, unsaturated carboxylic acid ester or amide having a releasable substituent such as a halogen group or a tosyloxy group, or a substitution reaction product with monofunctional or polyfunctional alcohol, amine, or thiol is also appropriate.

As the polymerizable compound, instead of the unsaturated carboxylic acid, a compound group substituted with unsaturated phosphonic acid or styrene, vinyl ether, or the like may be used.

Details of the structure of the polymerizable compound, the content of the polymerizable compound, the usage method of the polymerizable compound (whether being used singly or two or more kinds thereof are used in combination), or the like can be appropriately set according to the final performance design of the curable composition for forming the protective layer.

For example, in view of sensitivity, the polymerizable compound preferably has a structure in which a content of the unsaturated groups per molecule is high, and a bifunctional or higher functional group is preferable in many cases. In view of improving the film hardness, as the polymerizable compound, a trifunctional or higher functional compound (for example, a hexafunctional acrylate compound) is preferable.

As the polymerizable compound, both of the sensitivity and the strength can be adjusted by using compounds having different functional numbers or using a compound having or different polymerizable groups, for example, acrylic acid ester, methacrylic acid ester, a styrene-based compound, and a vinyl ether-based compound in combination is available.

As the polymerizable compound, a commercially available product may be used.

Examples of the commercially available product of the polymerizable compound include KAYARAD (registered trademark) PET-30 and KAYARAD (registered trademark) TPA-330 manufactured by Nippon Kayaku Co., Ltd., POLYVEST (registered trademark) 110M manufactured by Evonik Industries AG, and polyfunctional acrylate A-9300 (above all are trade names) manufactured by Shin-Nakamura Chemical Co., Ltd.

In a case where the curable composition for forming the protective layer contains the polymerizable compound, only one kind of the polymerizable compound may be contained, or two or more kinds thereof may be contained, if necessary.

The content ratio of the polymerizable compound in the curable composition for forming a protective layer is not particularly limited.

In a case where the curable composition for forming the protective layer contains the polymerizable compound, for example, the content ratio of the polymerizable compound in the curable composition for forming the protective layer is preferably 30 mass % to 99.5 mass %, more preferably 50 mass % to 99 mass %, and even more preferably 60 mass % to 98 mass % with respect to the total solid content of the curable composition for forming the protective layer.

A preferable aspect in a case where a polymer compound is used as the polymerizable compound is provided below.

Examples of the polymer compound include a curable resin such as a (meth)acrylic resin, a polyester resin, a urethane resin, or a fluorine-based resin.

In a case where the curable resin is used as the polymerizable compound, the curable resin may be used singly, or two or more kinds thereof may be used in combination, but, in view of the uniformity of the film, it is preferable to use the curable resin singly.

In view of the strength of the protective layer, it is preferable that the curable resin has a crosslinking structure.

The method of obtaining the curable resin having a crosslinking structure is not particularly limited, and examples thereof include a method of using a polyfunctional (meth)acrylate monomer that can be bonded to a reactive group included in the curable resin, for example, in a case where the curable resin is a (meth)acrylic resin, a method of introducing a reactive group (for example, a hydroxyl group) into a (meth)acrylic resin and reacting a crosslinking agent that reacts with the introduced reactive group.

Specific examples of the method of introducing the reactive group into the (meth)acrylic resin include a method of causing a (meth)acrylic resin including a structural unit derived from a (meth)acrylate monomer having a group including one or more kinds of active hydrogen, which is selected from the group consisting of a hydroxyl group, a primary amino group, and a secondary amino group to react with an isocyanate group-containing crosslinking agent, that is, a compound having two or more isocyanate groups in one molecule.

In a case where the (meth)acrylic resin having a reactive group is synthesized, it is preferable that polyfunctional (meth)acrylate monomers which are trifunctional or higher functional are used, since the crosslinking density of the obtained protective layer is increased, and the strength is further improved.

As the crosslinking agent, it is possible to appropriately use the well-known crosslinking agent.

Examples of the crosslinking agent include AD-TMP and A-9550 (above, all are trade names) manufactured by Shin-Nakamura Chemical Co., Ltd.

In a case where the curable composition for forming the protective layer contains a curable resin as the polymerizable compound, the content ratio of the curable resin in the curable composition for forming the protective layer is not particularly limited.

For example, the content ratio of the curable resin in the curable composition for forming the protective layer is preferably 30 mass % to 99.5 mass %, more preferably 50 mass % to 99 mass %, and even more preferably 60 mass % to 98 mass % with respect to the total solid content of the curable composition for forming the protective layer.

The content of the crosslinking agent to be used in combination with the curable resin is preferably 5 parts by mass to 80 parts by mass and more preferably 10 parts by mass to 50 parts by mass with respect to 100 parts by mass of the curable resin.

### Polymerization Initiator

The curable composition for forming a protective layer preferably contains the polymerization initiator.

The polymerization initiator is not particularly limited as long as the polymerization initiator is a compound that can generate initiating species that are required for the polymerization by applying energy, and the polymerization initiator can be appropriately selected from well-known photopolymerization initiators and thermal polymerization initiators.

For example, the photopolymerization initiator is preferably an initiator having photosensitivity to rays in a visible range from the ultraviolet region, may be an activator which generates some action with the photosensitized sensitizing agent to generate active radicals, or may be an initiator which initiates cationic polymerization according to the type of monomer.

Examples of the photopolymerization initiator include a halogenated hydrocarbon derivative such as a photopolymerization initiator having a triazine skeleton or a photopolymerization initiator having an oxadiazole skeleton, an acylphosphine compound such as acylphosphine oxide, an oxime compound such as hexaarylbiimidazole and an oxime derivative, organic peroxide, a thio compound, a ketone compound, aromatic onium salt, keto oxime ether, an aminoacetophenone compound, and hydroxyacetophenone.

Specific examples of the aminoacetophenone compound which is a photopolymerization initiator include compounds disclosed in JP2009-191179A of which an absorption wavelength is adjusted to a long wave light source such as 365 nm and 405 nm.

Specific examples of the photopolymerization initiator include an aminoacetophenone-based photopolymerization initiator disclosed in JP1998-291969A (JP-H10-291969A) and an acylphosphine oxide-based photopolymerization initiator disclosed in JP4225898B may be used.

Among these, as the photopolymerization initiator, an oxime-based compound is more preferable.

Specific examples of the oxime-based compound which is the photopolymerization initiator include compounds disclosed in JP2001-233842A, compounds disclosed in JP2000-080068A, compounds disclosed in JP2006-342166A, and compounds disclosed in [0073] to [0075] of JP2016-006475A.

As the photopolymerization initiator, a synthesized product may be used, or a commercially available product may be used.

As the photopolymerization initiator, for example, the following commercially available products can be used.

Examples of the hydroxyacetophenone-based initiator include IRGACURE (registered trademark) 184, IRGACURE (registered trademark) 500, IRGACURE (registered trademark) 2959, IRGACURE (registered trademark) 127, and DAROCUR (registered trademark) 1173 (trade names, all are manufactured by BASF SE).

Examples of the aminoacetophenone-based initiator include IRGACURE (registered trademark) 907, IRGACURE (registered trademark) 369, and IRGACURE (registered trademark) 379 (trade names: all are manufactured by BASF SE).

Examples of the acylphosphine-based initiator include IRGACURE (registered trademark) 819 and DAROCUR (registered trademark) TPO (trade names: all are manufactured by BASF SE).

Examples of the oxime ester compound which is an oxime-based initiator include IRGACURE (registered trademark) OXE01 and IRGACURE (registered trademark) OXE02 (trade names: all are manufactured by BASF SE).

Examples the like well-known cation polymerization initiator which is an polymerize initiator that initiates cation polymerization include well-known compounds such as a photopolymerization initiator for photo cationic polymerization, a photo-decoloring agent based on coloring agents, a photochromic agent, and known acid generators that are used in a micro resist or the like, and a mixture thereof.

Examples of the cationic polymerization initiator include an onium compound, an organic halogen compound, and a disulfone compound.

Examples of the onium compound include compounds such as diazonium salt, ammonium salt, iminium salt, phosphonium salt, iodonium salt, sulfonium salt, arsonium salt, and selenonium salt. Specific examples thereof include compounds disclosed in paragraphs to [0059] of JP2002-029162A.

In a case where the curable composition for forming a protective layer contains a polymerization initiator, one kind of the polymerization initiator may be contained, and, if necessary, two or more kinds thereof may be contained.

The content ratio of the polymerization initiator in the curable composition for forming a protective layer is not particularly limited.

In a case where the curable composition for forming a protective layer contains a polymerization initiator, for example, the content ratio of the polymerization initiator in the curable composition for forming a protective layer is preferably 0.1 mass % to 20 mass %, more preferably 0.3 mass % to 15 mass %, and even more preferably 0.4 mass % to 10 mass % with respect to the total solid content of the curable composition for forming a protective layer.

### Organic Solvent

In order to prepare the curable composition for forming a protective layer as a coating liquid, for example, an organic solvent can be included.

As long as the solubility of the respective components contained in the curable composition for forming a protective layer and the coating properties after the preparation, the kind of the organic solvent is not particularly limited. Specifically, it is preferable to select the kind of organic solvent considering the solubility or the dispersibility of the specific compound, the polymerizable compound, or the like, the shape of a surface coated with the coating liquid (that is, the curable composition), and the ease of handling.

Examples of the organic solvent include ester, ether, ketone, and aromatic hydrocarbon.

Examples of ester include ethyl acetate, acetate-n-butyl, isobutyl acetate, amyl formate, isoamyl acetate, isobutyl acetate, butyl propionate, isopropyl butyrate, ethyl butyrate, butyl butyrate, methyl lactate, ethyl lactate, oxyacetic acid alkyl ester (for example: methyl oxyacetate (methyl methoxyacetate, (methyl ethoxyacetate, or the like), ethyl oxyacetate (ethyl methoxyacetate, (ethyl ethoxyacetate, or the like), or butyl oxyacetate (butyl methoxyacetate or the like)), 3-oxypropionic acid alkyl ester (for example: methyl 3-oxypropionate (methyl 3-methoxypropionate, methyl 3-ethoxypropionate, or the like), ethyl 3-oxypropionate (ethyl 3-methoxypropionate, ethyl 3-ethoxypropionate, or the like)), 2-oxypropionic acid alkyl ester (for example: methyl 2-oxypropionate, (methyl 2-methoxypropionate, methyl 2-ethoxypropionate, or the like), ethyl 2-oxypropionate (ethyl 2-methoxypropionate, ethyl 2-ethoxypropionate, or the like), or propyl 2-oxypropionate (propyl 2-methoxypropionate or the like)), methyl 2-oxy-2-methylpropionate (methyl 2-methoxy-2-methylpropionate or the like), ethyl 2-oxy-2-methylpropionate (ethyl 2-ethoxy-2-methylpropionate or the like), methyl pyruvate, ethyl pyruvate, propyl pyruvate, methyl acetoacetate, ethyl acetoacetate, methyl 2-oxobutanoate, ethyl 2-oxobutanoate, cyclohexyl acetate, and 1-methyl-2-methoxyethyl propionate.

Examples of ether include diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether, propylene glycol monomethyl ether acetate (hereinafter, also referred to as “PGMEA”), diethylene glycol monoethyl ether acetate (hereinafter, also referred to as “ethyl carbitol acetate”), diethylene glycol monobutyl ether acetate (hereinafter, also referred to as “butyl carbitol acetate”), propylene glycol monoethyl ether acetate, and propylene glycol monopropyl ether acetate.

Examples of ketone include methyl ethyl ketone cyclohexanone, 2-heptanone, and 3-heptanone.

Preferable examples of the aromatic hydrocarbon include toluene and xylene.

In a case of containing an organic solvent, the curable composition for forming a protective layer may contain only one kind of the organic solvent and, if necessary, may contain two or more kinds thereof. In view of the solubility of the respective components contained in the curable composition for forming a protective layer and the improvement of the shape of the coated surface, it is preferable to select two or more kinds of the organic solvent.

In a case where the curable composition for forming a protective layer contains two or more kinds of organic solvents, it is preferable to contain two or more kinds selected from the group consisting of methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethyl carbitol acetate, butyl carbitol acetate, propylene glycol methyl ether, and propylene glycol methyl ether acetate.

In a case where the curable composition for forming a protective layer contains an organic solvent, the content of the organic solvent in the curable composition for forming a protective layer is preferably an amount in which the total solid content concentration in the curable composition for forming a protective layer becomes 10 mass % to 80 mass % and more preferably an amount in which the total solid content concentration becomes 15 mass % to 60 mass %.

### Other Components

In addition to the specific compound, the polymerizable compound, the polymerization initiator, the organic solvent, and the other ultraviolet absorbing agent, the curable composition for forming a protective layer may include various components (hereinafter, referred to as “other components”), if necessary.

Examples of the other components include a surfactant such as a nonionic surfactant, a cationic surfactant, and an anionic surfactant, an adhesion promoter, and an antioxidant. Examples of the other components include a sensitizing agent for improving the sensitivity of the photopolymerization initiator, a light stabilizer contributing to the stability of the photopolymerization initiator, and a thermal polymerization inhibitor.

### Adhesive Layer or Pressure Sensitive Adhesive Layer

The protective sheet of the first aspect may further have an adhesive layer or a pressure sensitive adhesive layer on the surface of the protective layer opposite to the support.

The adhesive or the pressure sensitive adhesive contained in the adhesive layer or the pressure sensitive adhesive layer is not particularly limited.

Examples of the pressure sensitive adhesive include those which are the same as the pressure sensitive adhesive contained in the pressure sensitive adhesive layer in the protective sheet of the second aspect described below.
Examples of the adhesive include a urethane resin-based adhesive, a polyester-based adhesive, an acrylic resin-based adhesive, an ethylene vinyl acetate resin-based adhesive, a polyvinyl alcohol-based adhesive, a polyamide-based adhesive, and a silicone-based adhesive, and in view of the higher adhesive strength, a urethane resin-based adhesive and a silicone-based adhesive are preferable.

As the adhesive agent, a commercially available product can be used.

Examples of the commercially available product of the adhesive include a urethane resin-based adhesive (trade name: LIS-073-50U) of Toyo Ink Co., Ltd.

It is preferable that the adhesive is used in combination with a curing agent (for example, CR-001 (trade name) of Toyo Ink Co., Ltd.).

In a case where the protective sheet according to the first aspect has an adhesive layer or a pressure sensitive adhesive layer, the thickness of the adhesive layer or the pressure sensitive adhesive layer is preferably in the range of 5 μm to 100 μm in view of compatibility between the pressure sensitive force and the handleability.

### Hard Coat Layer

In view of improving the scratch resistance, it is preferable that the protective sheet of the first aspect further has a hard coat layer on the protective layer. In view of further improving the scratch resistance, it is preferable to have the hard coat layer on the outermost surface of the protective sheet.

As the hard coat layer, for example, hard coat layers disclosed in JP2013-045045A, JP2013-043352A, JP2012-232459A, JP2012-128157A, JP2011-131409A, JP2011-131404A, JP2011-126162A, JP2011-075705A, JP2009-286981A, JP2009-263567A, JP2009-075248A, JP2007-164206A, JP2006-096811A, JP2004-075970A, JP2002-156505A, JP2001-272503A, WO12/018087A, WO12/098967A, WO12/086659A, and WO11/105594A can be used.

In a case where the protective sheet of the first aspect has a hard coat layer, the thickness of the hard coat layer is preferably in the range of 5 μm to 100 μm in view of further improving the scratch resistance.

The hard coat layer may be formed by any method of a wet coating method and a dry coating method (vacuum film formation), but is preferably formed by a wet coating method in which the productivity is excellent.

In addition, it is possible to impart blue light shielding properties to the hard coat layer by causing the specific compound to be contained in the composition for forming a hard coat layer (so-called a composition for forming a hard coat layer).

### Second Aspect

The protective sheet of the second aspect is a protective sheet having a support and a pressure sensitive adhesive layer that is disposed on at least one surface of the support and contains a compound (that is, the specific compound) represented by Formula (1) and a pressure sensitive adhesive.

In the protective sheet of the second aspect, the pressure sensitive adhesive layer may be disposed on one surface of the support or may be disposed on both surfaces of the support.

Without deteriorating the effect of the present invention, the protective sheet of the second aspect may have another layer between the support and the pressure sensitive adhesive layer.

Hereinafter, the protective sheet of the second aspect is specifically described.

### Support

In the protective sheet of the second aspect, the support is preferably a transparent support (that is, a transparent support).

The “support” in the protective sheet of the second aspect has the same meaning as the “support” in the protective sheet of the first aspect, the preferable aspect thereof is also the same, and thus the description thereof is omitted.

### Pressure Sensitive Adhesive Layer

The pressure sensitive adhesive layer is a layer containing a compound (that is, the specific compound) represented by Formula (1) and a pressure sensitive adhesive.

Since the protective sheet of the second aspect has a pressure sensitive adhesive layer containing the specific compound and the pressure sensitive adhesive, the blue light in the wavelength range of at least 380 nm to 400 nm can be shielded, and thus a change of tint is hardly recognized in a case where an object is viewed through the sheet. The protective sheet of the second aspect has pressure sensitive adhesive properties.

### Compound Represented by Formula (1)

The pressure sensitive adhesive layer contains the compound (that is, the specific compound) represented by Formula (1).

The “compound (that is, the specific compound) represented by Formula (1)” in the protective sheet of the second aspect is the same as the “compound (that is, the specific compound) represented by Formula (1)” in the protective sheet of the first aspect, the preferable aspect thereof is also the same, and thus the description thereof is omitted.

### Pressure Sensitive Adhesive

The pressure sensitive adhesive layer contains a pressure sensitive adhesive.

The pressure sensitive adhesive is not particularly limited, as long as the pressure sensitive adhesive can apply required pressure sensitive properties, and well-known pressure sensitive adhesives can be used.

Examples of the pressure sensitive adhesive include an acrylic pressure sensitive adhesive rubber-based pressure sensitive adhesive, and a silicone-based pressure sensitive adhesive.

The acrylic pressure sensitive adhesive is a pressure sensitive adhesive including a polymer (that is, a (meth)acrylic polymer) of a (meth)acrylic monomer.

The acrylic pressure sensitive adhesive may contain other components, for example, components such as a viscosity imparting agent or a rubber component as described below, as long as a polymer of the (meth)acryl monomer (that is, a (meth)acyl polymer) is a major component, specifically, as long as the content of the polymer of the (meth)acryl monomer (that is, a (meth)acyl polymer) is 50 mass % or more with respect to the total amount of the pressure sensitive adhesive.

As the pressure sensitive adhesive, acrylic pressure sensitive adhesives, ultraviolet (UV) curable pressure sensitive adhesives, and silicone pressure sensitive adhesives disclosed in Chapters 2 of “Characterization evaluation of release paper, release film, and pressure sensitive adhesive tape, and control technique thereof”, 2004, Information Mechanism are appropriately used.

The (meth)acrylate monomer is preferably a (meth)acrylate monomer having a hydrocarbon group having 4 or more carbon atoms, and specific examples thereof include 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, n-hexadecyl (meth)acrylate, stearyl (meth)acrylate, isobornyl (meth)acrylate, dicyclopentenyl (meth)acrylate, dicyclopentanyl (meth)acrylate, and dicyclopentenyloxyethyl (meth)acrylate.

The (meth)acrylic polymer as the pressure sensitive adhesive may have a crosslinking structure.

The method of obtaining the (meth)acrylic polymer having a crosslinking structure is not particularly limited, and examples thereof include a method of using a bifunctional (meth)acrylate monomer, a method of introducing a reactive group (for example, hydroxyl group) into a (meth)acrylic polymer and causing the introduced reactive group and a crosslinking agent that reacts with the reactive group to react with each other.

Specific examples of the method of introducing the reactive group into the (meth)acrylic polymer include a method of causing a (meth)acrylic polymer including a structural unit derived from a (meth)acrylate monomer having a group having at least one kinds of active hydrogen, which is selected from the group consisting of a hydroxy group, a primary amino group, and a secondary amino polymer to react with the isocyanate group-containing crosslinking agent, that is, a compound having two or more isocyanate groups in one molecule.

As the pressure sensitive adhesive, a commercially available product can be used.

Examples of the commercially available product of the pressure sensitive adhesive include a silicone-based pressure sensitive adhesive of Dow Corning Corporation (trade name: 7652 ADHESIVE).

In view of sufficiently exhibiting pressure sensitive adhesive properties, the content ratio of the pressure sensitive adhesive in the pressure sensitive adhesive layer is preferably 10 mass % to 50 mass % and more preferably 15 mass % to 40 mass % with respect to the total mass of the pressure sensitive adhesive layer.

### Viscosity Imparting Agent

The pressure sensitive adhesive layer may contain a viscosity imparting agent.

Examples of the viscosity imparting agent include a petroleum-based resin such as an aromatic petroleum resin, an aliphatic petroleum resin, an aliphatic/aromatic hybrid petroleum resin, and a resin by C9 fraction; a terpene-based resin such as an α pinene resin, a β pinene resin, a resin obtained by copolymerizing any mixture of α pinene/β pinene/dipentene, a terpene phenol copolymer, a hydrogenated terpene phenolic resin, an aromatic modified hydrogenated terpene resin, and an abietic acid ester-based resin; a rosin-based resin such as a partially hydrogenated gum rosin resin, an erythritol-modified wood rosin resin, a tall oil rosin resin, a wood rosin resin, gum rosin, a rosin-modified maleic acid resin, polymerized rosin, rosin phenol, and rosin ester, and a coumarone indene resin such as a coumarone indene styrene copolymer.

In a case where the pressure sensitive adhesive layer contains a viscosity imparting agent, the content ratio of the viscosity imparting agent in the pressure sensitive adhesive layer is preferably 10 mass % to 200 mass % and more preferably 20 mass % to 100 mass % with respect to the total mass of the pressure sensitive adhesive contained in the pressure sensitive adhesive layer.

### Rubber Component

The pressure sensitive adhesive layer may further contain a rubber component as a softener.

Examples of the rubber component include polyolefin or modified polyolefin.

Examples of the rubber component include natural rubber, polyisobutylene, polybutadiene, modified liquid polybutadiene, hydrogenated polybutadiene, polyisoprene, hydrogenated polyisoprene, polybutene, a styrene butadiene copolymer, and a mixture including any two or more components selected from these groups.

In a case where the pressure sensitive adhesive layer contains a rubber component, the content ratio of the rubber component in the pressure sensitive adhesive layer is preferably 10 mass % to 200 mass % and more preferably 20 mass % to 100 mass % with respect to the total mass of the pressure sensitive adhesive contained in the pressure sensitive adhesive layer.

### Ultraviolet Absorbing Agent

The pressure sensitive adhesive layer contains a compound (that is, the other ultraviolet absorbing agent) having ultraviolet absorbing ability other than the above specific compound.

The “other ultraviolet absorbing agent” in the protective sheet of the second aspect is the same as the “other ultraviolet absorbing agent” in the protective sheet of the first aspect, the preferable aspect thereof is also the same, and thus the description thereof is omitted.

The thickness of the pressure sensitive adhesive layer is not particularly limited.

For example, in view of the handleability and the adhesive force, the thickness of the pressure sensitive adhesive layer is preferably in the range of 0.1 μm to 10 μm.

### Method of Forming Pressure Sensitive Adhesive Layer

Examples of the method of forming a pressure sensitive adhesive layer include the following method. However, the method of forming a pressure sensitive adhesive layer in the protective sheet of the present disclosure is not limited to the following method.

A composition for forming a pressure sensitive adhesive layer is prepared by mixing the specific compound, the pressure sensitive adhesive, and, if necessary, the other ultraviolet absorbing agent and various additives used in combination as desired (a crosslinking agent, a viscosity imparting agent, and the like). Subsequently, the surface of a support is coated with the composition for forming a pressure sensitive adhesive layer by a coating method well-known in the related art. Subsequently, the coated film formed on the surface of the support is dried. By the above, a pressure sensitive adhesive layer can be formed.

### Image Display Device

The image display device of the present disclosure is an image display device including the aforementioned protective sheet of the present disclosure.

That is, the image display device according to the present disclosure includes an image display element and the protective sheet according to the present disclosure, and the protective sheet is arranged on an image display portion (for example, a display) that displays an image, that is, the side of the image display portion viewed by the user.

In an image display portion (for example, a display) comprising the protective sheet of the present disclosure, the blue light in the wavelength range of at least 380 nm to 400 nm is shielded, and in a case where an object is viewed, compared with a case where a protective sheet is not provided, a change of tint is hardly recognized.

Examples of the image display device according to the present disclosure include an image display device such as a liquid crystal display (LCD), a plasma display, an electroluminescent display, a cathode ray display device.

An aspect of the image display device according to the present disclosure also includes not only a large-area image display device but also an aspect having various displays such as a smartphone and a tablet terminal on which the touch panel described below is mounted.

Examples of types of the liquid crystal display device include a Twisted Nematic (TN) type, a Super-Twisted Nematic (STN) type, a Triple Super Twisted Nematic (TSTN) type, a multi domain type, a Vertical Alignment (VA) type, an In Plane Switching (IPS) type, and an Optically Compensated Bend (OCB) type.

It is particularly preferable that the image display device of the present disclosure is a liquid crystal display device in which the protective sheet of the present disclosure is disposed on the outermost surface of at least one surface of the liquid crystal cell. In this aspect, the image display element is a liquid crystal display element.

In the image display device of the present disclosure, it is preferable that the image display element is an organic electroluminescence display element.

### Touch Panel

An image display device having a display comprising a touch panel is included in the image display device to which the protective sheet of the present disclosure can be applied.

The touch panel is not particularly limited and can be appropriately selected depending on the purpose.

Examples of the touch panel include a surface type capacitive touch panel, a projection type capacitive touch panel, and a resistive film type touch panel.

The touch panel includes a so-called touch sensor and a touch pad.

The layer configuration of the touch panel sensor electrode portion in the touch panel may be any one of a laminate method in which two transparent electrodes are laminated, a method in which transparent electrodes are provided on both sides of one substrate, a one-side jumper method, or a through hole method, and a one-side lamination method. In the projection type capacitive touch panel, an alternating current (AC) drive is preferable to a direct current (DC) drive, and a drive method with less voltage application time to an electrode is more preferable.

### EXAMPLES

Hereinafter, the present invention will be described more specifically with reference to examples, but the present invention is not limited to the following examples without departing from the gist thereof.

### Manufacturing of Lens

### Example 1

100 parts by mass of MR-8 (registered trademark) [trade name, refractive index: 1.60, Mitsui Chemicals, Inc.], which was a precursor monomer of a thiourethane resin, 0.1 parts by mass of the specific compound 1-2, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Example 2

100 parts by mass of MR-7 (registered trademark) [trade name, refractive index: 1.67, Mitsui Chemicals, Inc.], which was a precursor monomer of a thiourethane resin, 0.1 parts by mass of the specific compound I-2, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Example 3

100 parts by mass of MR-10 (registered trademark) [trade name, refractive index: 1.67, Mitsui Chemicals, Inc.], which was a precursor monomer of a thiourethane resin, 0.1 parts by mass of the specific compound I-7, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Example 4

100 parts by mass of MR-8 (registered trademark) [trade name, refractive index: 1.60, Mitsui Chemicals, Inc.], which was a precursor monomer of a thiourethane resin, 0.1 parts by mass of the specific compound I-2, 0.1 parts by mass of UV-1 (a compound having the following structure) that is the other ultraviolet absorbing agent, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

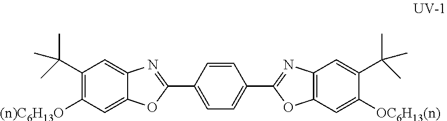

### Example 5

100 parts by mass of MR-8 (registered trademark) [trade name, refractive index: 1.60, Mitsui Chemicals, Inc.], which was a precursor monomer of a thiourethane resin, 0.1 parts by mass of the specific compound I-10, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Example 6

100 parts by mass of PANLITE (registered trademark) L-1250WP [trade name, refractive index: 1.54 an aromatic polycarbonate resin powder manufactured by an interfacial condensation polymerization method from bisphenol and phosgene, viscosity average molecular weight: 24,000, Teijin Limited], which is a polycarbonate resin, and 0.1 parts by mass of the specific compound I-2 were mixed using a blender to obtain a resin composition. The obtained resin composition was melt-kneaded with a vented biaxial extruder so as to obtain pellets. TEX30α (specification: perfect meshing, same direction rotation, double thread screw) of The Japan Steel Works, Ltd. was used as the vented biaxial extruder. The kneading zone was of one type in front of the vent port. With respect to the extrusion conditions, a jetting amount was set to 30 kg/hr, a screw rotation speed was set to 150 rpm (round per minute), a vent vacuum was set to 3 kPa, and an extrusion temperature from a first supply port to a die portion was set to 280° C. The obtained pellets were dried at 120° C. for five hours by using a hot air circulating dryer, and then an injection molding machine (injection conditions: cylinder temperature of 340° C. and the die temperature of 80° C.) was used, so as to manufacture a lens for spectacles having a thickness of 2 mm. It was confirmed that the manufactured lens for spectacles was transparent by visual observation.

### Example 7

100 parts by mass of MR-174 (registered trademark) [trade name, refractive index: 1.74, Mitsui Chemicals, Inc.], which was a precursor monomer of a thiourethane resin, 0.1 parts by mass of the specific compound I-2, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Example 8

As a precursor of the episulfide resin, 100 parts by mass (refractive index: 1.7) of bis-β epithiopropyl disulfide, 10 parts by mass of 4,8-dimercaptomethyl-1,11-dimercapto-3,6,9-trithiaundecane, 0.1 parts by mass of the specific compound 1-2, and 0.01 parts by mass of N,N-dimethylcyclohexylamine that was a polymerization catalyst were mixed with a blender so as to obtain a mixture. A mold was filled with the obtained mixture, was left at 30° C. for eight hours, and then was cured at 100° C. for 10 hours, such that a lens for spectacles having a thickness of 2 mm was manufactured. It was confirmed that the manufactured lens for spectacles was transparent by visual observation.

### Example 9

100 parts by mass of MR-174 (registered trademark) [trade name, refractive index: 1.74, Mitsui Chemicals, Inc.], which was a precursor monomer of a thiourethane resin, 0.1 parts by mass of the specific compound 1-2, 0.01 parts by mass of UV-2 (a compound having the following structure) that is the other ultraviolet absorbing agent, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

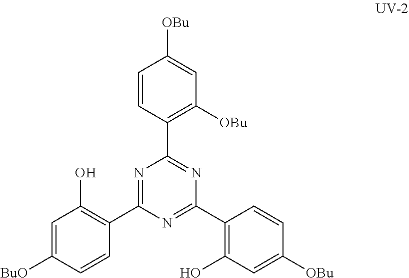

### Example 10

100 parts by mass of MR-174 (registered trademark) [trade name, refractive index: 1.74, Mitsui Chemicals, Inc.], which was a precursor monomer of a thiourethane resin, 0.1 parts by mass of the specific compound I-2, 0.01 parts by mass of UV-3 (a compound having the following structure) that is the other ultraviolet absorbing agent, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

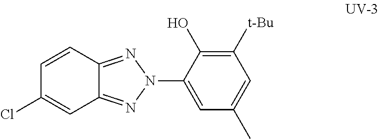 [SMILES: Cc1cc(-n2nc3ccc(Cl)cc3n2)c(O)c(C(C)(C)C)c1]

### Comparative Example 1

100 parts by mass of MR-8 (registered trademark) [trade name, refractive index: 1.60, Mitsui Chemicals, Inc.], which was a precursor monomer of a thiourethane resin, 0.1 parts by mass of ADEKASTAB (registered trademark) LA-24 [trade name, 2-(2H-Benzotriazol-2-yl)-4,6-bis(1-methyl-1-phenylethyl)phenol, benzotriazole-based ultraviolet absorbing agent, ADEKA Corporation] which was a comparative compound, and 0.01 parts by mass of dibutyltin dichloride that was a polymerization catalyst were mixed so as to obtain a resin composition. A mold was filled with the obtained resin composition and then was heated at 130° C. for two hours to be cured, such that a lens for spectacles having a thickness of 2 mm was manufactured. It was confirmed that the manufactured lens for spectacles was transparent by visual observation.

### Manufacturing of Spectacles

The respective lenses for spectacles of Examples 1 to 10 and Comparative Example 1 were mounted on a spectacle frame so as to manufacture spectacles.

### Evaluation

1. Eye fatigue

For each pair of spectacles, two evaluation monitors were asked to wear the manufactured spectacles, and whether eye fatigue was felt or not after three hours of continuous viewing of the display of the image display device was evaluated.

As a result, both of the two evaluation monitors wearing the spectacles equipped with the lenses for spectacles of Examples 1 to 10 evaluated that eye fatigue was not felt.

Meanwhile, both of the two evaluation monitors wearing with the spectacles equipped with the lens for spectacles of Comparative Example 1 evaluated that eye fatigue was felt.

2. Color reproducibility

For each pair of spectacles, two evaluation monitors were asked to wear the manufactured spectacles, and an image displayed on the display of the image display device was viewed. In a case where an image was viewed through the lens for spectacles, whether a change of tint is recognized before and after wearing was evaluated.

As a result, both of the two evaluation monitors wearing the spectacles equipped with the lenses for spectacles of Examples 1 to 10 evaluated that a change of tint was hardly recognized.

Meanwhile, both of the two evaluation monitors wearing the spectacles equipped with the lenses for spectacles of Comparative Example 1 evaluated that a change of tint was recognized.

3. Transmittance

A transmittance at a wavelength of 400 nm of each of the lenses for spectacles manufactured in Examples 1 to 10 and Comparative Example 1 was measured. As the determination device, a spectrophotometer (Model number: UV 3150) of Shimadzu Corporation was used. The lower value of the measured transmittance indicates that the shielding properties of the blue light in the wavelength of 400 nm were satisfactory. Results thereof are as presented in Table 1.

4. Haze
Hazes of the lenses for spectacles manufactured in Examples 1 to Example 10 and Comparative Example 1 were measured. As the determination device, a haze meter (Model number: NDH 7000) of Nippon Denshoku Industries Co., Ltd. was used. The lower value of the measured haze indicates more excellent transparency. Results thereof are as presented in Table 1.

5. Light resistance

Light resistance of the lenses for spectacles manufactured in Examples 1 to 10 and Comparative Example 1 was evaluated. First, the transmittances of the lenses for spectacles in the wavelength of 400 nm were measured by using a spectrophotometer (Model number: UV 3150) of Shimadzu Corporation.

Subsequently, by using a super accelerated weather fastness tester [Product name: EYE SUPER UV TESTER, Iwasaki Electric Co., Ltd.], the lens for spectacles was irradiated with the light of a metal halide lamp (cut about 290 nm or less), under the conditions of the illuminance of 90 mW/cm², a temperature of 63° C., and the relative humidity of 50%, for 60 hours. After the light irradiation, the transmittance of the lens for spectacles at a wavelength of 400 nm was measured with a spectrophotometer (model number: UV 3150) of Shimadzu Corporation as described above.

The width of change in transmittance at a wavelength of 400 nm before and after light irradiation was calculated, and a case where the width of change was less than 5% was evaluated that the light resistance was “particularly satisfactory”, a case where the width of change was 5% or more and less than 10% was evaluated that the light resistance was “satisfactory”, and a case where the width of change was 10% or more was evaluated that the light resistance was “poor”. Results thereof are as presented in Table 1.

6. Yellowishness

The lenses for spectacles manufactured in Examples 1 to 10 and Comparative Example 1 were placed on white paper. For respective spectacles, one evaluation monitor was asked to visually observe the lenses for spectacles on paper and evaluate whether the lenses for spectacles had yellowishness. Results thereof are as presented in Table 1.

TABLE 1

| | | | | Evaluation | | | |
|---|---|---|---|---|---|---|---|
| | | | Other ultraviolet | | | Light | |
| | Compound | Resin | absorbing agents | Transmittance | Haze | resistance | Yellowishness |
| Example 1 | Specific compound I-2 | Urethane resin | — | 0.1% | 0.1 | Satisfactory | None |
| | | (Material: MR-8) | | | | | |
| Example 2 | Specific compound I-2 | Urethane resin | — | 0.1% | 0.1 | Satisfactory | None |
| | | (Material: MR-7) | | | | | |
| Example 3 | Specific compound I-7 | Urethane resin | — | 0.1% | 0.1 | Satisfactory | None |
| | | (Material: MR-10) | | | | | |
| Example 4 | Specific compound I-2 | Urethane resin | UV-1 | 0.1% | 0.2 | Particularly | None |
| | | (Material: MR-8) | | | | satisfactory | |
| Example 5 | Specific compound I-10 | Urethane resin | — | 0.5% | 0.2 | Satisfactory | None |
| | | (Material: MR-8) | | | | | |
| Example 6 | Specific compound I-2 | Polycarbonate resin | — | 0.1% | 0.1 | Satisfactory | None |
| | | (Material: PANLITE | | | | | |
| | | L-1250WP) | | | | | |
| Example 7 | Specific compound I-2 | Urethane resin | — | 0.1% | 0.1 | Satisfactory | None |
| | | (Material: MR-174) | | | | | |
| Example 8 | Specific compound I-2 | Episulfide resin | — | 0.2% | 0.1 | Satisfactory | None |
| Example 9 | Specific compound I-2 | Urethane resin | UV-2 | 0.1% | 0.3 | Particularly | None |
| | | (Material: MR-174) | | | | satisfactory | |
| Example10 | Specific compound I-2 | Urethane resin | UV-3 | 0.1% | 0.3 | Particularly | None |
| | | (Material: MR-174) | | | | satisfactory | |
| Comparative | ADEKASTAB LA-24 | Urethane resin | — | 3.0% | 2.2 | Poor | Yellowishness |
| Example 1 | | (Material: MR-8) | | | | | |

As shown in Table 1, it was confirmed that, compared to the lens for spectacles of Comparative Example 1, the lenses for spectacles of Examples 1 to 10 had a low value of transmittance at a wavelength of 400 nm and had excellent shielding properties of blue light.

It was confirmed that, compared with the lens for spectacles of Comparative Example 1, the lenses for spectacles of Examples 1 to 10 had low haze values and excellent transparency.

It was confirmed that, compared with the lens for spectacles of Comparative Example 1, the lenses for spectacles of Examples 1 to 10 had excellent light resistance and thus hardly had yellowishness.

### Manufacturing of Protective Sheet

### Example 11

### Preparation of Curable Composition for Forming Protective Layer

Components described in “Formulation of curable composition for forming protective layer” were mixed so as to manufacture the curable composition for forming a protective layer.

### Formulation of Curable Composition for Forming Protective Layer

| | | |
|---|---|---|
| The specific compound I-2 | 5 | parts by mass |
| KAYARAD PET-30 (trade name, polyfunctional | 50 | parts by mass |
| acrylate, polymerizable compound, Nippon | | |
| Kayaku Co., Ltd.) | | |
| PGMEA (propylene glycol monomethyl ether | 100 | parts by mass |
| acetate, organic solvent) | | |
| IRGACURE (registered trademark) 819 (trade | 1 | part by mass |
| name, photopolymerization initiator, BASF SE) | | |

A polyethylene terephthalate (PET) film (thickness: 125 μm) which was a transparent support was coated with the curable composition for forming a protective layer obtained above, so as to form a coating film of the curable composition for forming a protective layer. The coating film was formed such that the transmittance at the maximum absorption wavelength of the specific compound I-2 was 1% in the dried thickness of the film. The formed coating film was dried at 80° C. for five minutes under reduced pressure. The coated film after drying is irradiated with ultraviolet light of 100 mW/cm² with an ultraviolet lamp at room temperature under a nitrogen atmosphere so as to cure the coating film, such that a protective layer that was a layer including the specific compound I-2 was formed. The content of the specific compound I-2 per unit area included in the protective layer was 1.2 mmol/m². The content of the specific compound I-2 per unit area included in the protective layer was calculated from the transmittance of the protective layer.

Subsequently, the surface of the transparent support on which the protective layer was not formed was coated with a silicone-based pressure sensitive adhesive (trade name: 7652 ADHESIVE, Toray Dow Corning Corporation) in an amount such that the thickness of the dried film was 30 μm, so as to form a coating film. Subsequently, the formed coating film was dried to form a pressure sensitive adhesive layer, such that a protective sheet having a configuration of a protective layer/a transparent support/a pressure sensitive adhesive layer was obtained.

### Example 12

In Example 11, a protective sheet was manufactured by performing the same operation as in Example 11 except that the “specific compound I-7” was used instead of the “specific compound I-2” in the “Formulation of curable composition for forming protective layer”.

### Example 13

In Example 11, a protective sheet was manufactured by performing the same operation as in Example 11 except that the “specific compound I-2 and UV-3 [mass ratio (9:1)]” was used instead of the “specific compound I-2” in the “Formulation of curable composition for forming protective layer”.

### Example 14

In Example 11, a protective sheet was manufactured by performing the same operation as in Example 11 except that a coating film was formed such that the thickness of the protective layer was 60%.

### Comparative Example 2

In Example 11, a protective sheet was manufactured by performing the same operation as in Example 11 except that “UV-3” was used instead of the “specific compound I-2” in the “Formulation of curable composition for forming protective layer”.

### Evaluation

1. Blue light shielding properties

The transmittance in the wavelength of 380 nm of the protective sheet manufactured in Examples 11 to 14 and Comparative Example 2 was measured. As the determination device, a spectrophotometer (Model number: UV 3150) of Shimadzu Corporation was used.

In a case where a value of the measured transmittance in the wavelength of 380 nm was 5.00% or less, it was evaluated that the blue light shielding properties of the protective sheet in the wavelength of 380 nm was constant. With respect to the blue light shielding properties of the protective sheet in the wavelength of 380 nm, in a case where a value of the measured transmittance in the wavelength of 380 nm was less than 1.00%, the evaluation was performed to be satisfactory, and in a case where a value was 0.10% or less, the evaluation was performed to be extremely satisfactory. Results thereof are as presented in Table 2.

2. Transparency

The transmittances in the wavelength of 400 nm of the protective sheets manufactured in Examples 11 to 14 and Comparative Example 2 were measured. As the determination device, a spectrophotometer (Model number: UV 3150) of Shimadzu Corporation was used.
In a case where a value of the measured transmittance in the wavelength of 400 nm was 95.0% or more, it was evaluated that the transparency of the protective sheet was constant. The transparency of the protective sheet was evaluated as satisfactory in a case where a value of the measured transmittance in the wavelength of 400 nm was 99.0% or more, and was evaluated as extremely satisfactory in a case where the value was 99.9% or more. Results thereof are as presented in Table 2.

3. Color reproducibility of image

3-1. Color reproducibility of white image

The protective sheets manufactured in Examples 11 to 14 and Comparative Example 2 were respectively disposed on liquid crystal displays, a white image was displayed, and one evaluation monitor was asked to visually observe the displayed image with respect to the protective sheets.

In a case where the image looks white, the color reproducibility of the white image was evaluated as “satisfactory”, and in a case where the image looks like a color other than white, the color reproducibility of the white image was evaluated as “poor”.

3-2. Color reproducibility of full color image

The protective sheets manufactured in Examples 11 to 14 and Comparative Example 2 were respectively disposed on liquid crystal displays, a full color image was displayed, and one evaluation monitor was asked to visually observe the displayed image with respect to the respective protective sheets.

Before and after the disposition of the protective sheets, in a case where discomfort was not felt in colors of the full color image, the color reproducibility of the full color image was evaluated as “satisfactory”, and in a case where it was confirmed that tints of the full color image were changed, the color reproducibility of the full color image was evaluated as “poor”.

In a case where the evaluation results of both of “3-1. Color reproducibility of white image” and “3-2. Color reproducibility of full color image” were satisfactory, the color reproducibility of the image of the protective sheet was evaluated as “satisfactory”, and in a case where at least one of the evaluation results was poor, the color reproducibility of the image of the protective sheet was evaluated as “poor”. Results thereof are as presented in Table 2.

TABLE 2

| | | | Protective layer | | | | | |
|---|---|---|---|---|---|---|---|---|
| | | | Compound | | | | | |
| | | | | Maximum | | | | |
| | Support | | | absorption | | | | |
| | | Thickness | | wavelength | Content | Polymerizable | Polymerization | Thickness |
| | Material | [μm] | Kind | [nm] | [mmol/m²] | compound | initiator | [μm] |
| Example 11 | PET | 125 | Specific | 370 | 1.2 | Polyfunctional acrylate | Photopolymerization | 5 |
| | | | compound | | | KAYARAD PET-30 | initiator | |
| | | | I-2 | | | | IRGACURE 819 | |
| Example 12 | PET | 125 | Specific | 370 | 1.2 | Polyfunctional acrylate | Photopolymerization | 5 |
| | | | compound | | | KAYARAD PET-30 | initiator | |
| | | | I-7 | | | | IRGACURE 819 | |
| Example 13 | PET | 125 | Specific | 370 | 1.2 | Polyfunctional acrylate | Photopolymerization | 5 |
| | | | compound | | | KAYARAD PET-30 | initiator | |
| | | | I-2 + | | | | IRGACURE 819 | |
| | | | UV-3 | | | | | |
| | | | (9:1) | | | | | |
| Example 14 | PET | 125 | Specific | 370 | 1.2 | Polyfunctional acrylate | Photopolymerization | 3 |
| | | | compound | | | KAYARAD PET-30 | initiator | |
| | | | I-2 | | | | IRGACURE 819 | |
| Comparative | PET | 125 | UV-3 | 350 | 1.2 | Polyfunctional acrylate | Photopolymerization | 5 |
| Example 2 | | | | | | KAYARAD PET-30 | initiator | |
| | | | | | | | IRGACURE 819 | |

| | | | Evaluation | | |
|---|---|---|---|---|---|
| | | | Blue light | | |
| | Pressure sensitive | | shielding | | |
| | adhesive layer | | properties | Transparency | |
| | Pressure | | 380 nm | 400 nm | Color |
| | sensitive | Thickness | transmittance | transmittance | reproducibility |
| | adhesive | [μm] | [%] | [%] | of image |
| Example 11 | Silicone-based | 30 | 0.10 | 99.9 | Satisfactory |
| Example 12 | Silicone-based | 30 | 0.10 | 99.9 | Satisfactory |
| Example 13 | Silicone-based | 30 | 0.10 | 99.9 | Satisfactory |
| Example 14 | Silicone-based | 30 | 0.16 | 99.9 | Satisfactory |
| Comparative | Silicone-based | 30 | 4.00 | 89.0 | Poor |
| Example 2 | | | | | |

As presented in Table 2, it was confirmed that all of the protective sheets of Examples 11 to 14 containing the specific compound had a transmittance of less than 1.00% in a wavelength of 380 nm and excellent blue light shielding properties. It was confirmed that all of the protective sheets of Examples 11 to 14 had a transmittance of 99.9% at a wavelength of 400 nm, and very high transparency. All of the protective sheets of Examples 11 to 14 had satisfactory color reproducibility of the images.

Meanwhile, it was confirmed that the protective sheet of Comparative Example 2 that contains a compound (that is, an ultraviolet absorbing agent that is not the compound represented by Formula (1)) other than the specific compound had a transmittance of 4.00% in the wavelength of 380 nm and low blue light shielding properties. With respect to the protective sheet of Comparative Example 2, the transmittance in the wavelength of 400 nm was 89.0%, and coloration in yellow was visually observed, and thus it was confirmed that the protective sheet of Comparative Example 2 was deteriorated in transparency compared with the protective sheets of Examples 11 to 14. The protective sheet of Comparative Example 2 had deteriorated color reproducibility of the image.

The disclosures of JP2016-253855 filed on Dec. 27, 2016 and JP2017-162720 filed on Aug. 25, 2017 are hereby incorporated by reference in their entirety.

All documents, patent applications, and technical standards described in the present specification are incorporated in the present specification by reference to a degree as in a case where individual documents, patent applications, and technical standards are specifically and individually described.

What is claimed is:

1. A lens for spectacles comprising:
a resin; and
a compound represented by Formula (1), 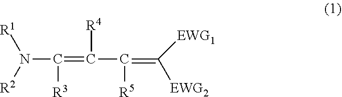
in Formula (1), EWG₁ and EWG₂ each independently represent a group having a Hammett's substituent constant σp value of 0.2 or more, R¹ and R² each independently represent an alkyl group, an aryl group, or a heteroaryl group, and R³, R⁴, and R⁵ each independently represent a hydrogen atom or a substituent.

2. The lens for spectacles according to claim 1,
wherein, in Formula (1), EWG₁ and EWG₂ each independently represent COOR⁶, SO₂R⁷, CN, or COR⁸, and R⁶, R⁷, and R⁸ each independently represent an alkyl group, an aryl group, or a heteroaryl group.

3. The lens for spectacles according to claim 1,
wherein, in Formula (1), EWG₁ and EWG₂ each independently represent COOR⁶, SO₂R⁷, CN, or COR⁸, R⁷ represents an aryl group, and R⁶ and R⁸ each independently represent an alkyl group.

4. The lens for spectacles according to claim 1,
wherein, in Formula (1), any one of EWG₁ or EWG₂ represents COOR⁶, and the other represents SO₂R⁷ or CN, R⁶ represents an alkyl group, and R⁷ represents an aryl group.

5. The lens for spectacles according to claim 1,
wherein, in Formula (1), R¹ and R² each independently represent an alkyl group.

6. The lens for spectacles according to claim 1,
wherein, in Formula (1), R³, R⁴, and R⁵ represent a hydrogen atom.

7. The lens for spectacles according to claim 1,
wherein the resin is at least one resin selected from the group consisting of a urethane resin or a polycarbonate resin.

8. The lens for spectacles according to claim 7,
wherein the urethane resin is a thiourethane resin.

9. The lens for spectacles according to claim 1,
wherein a refractive index of the resin is higher than 1.65.

10. The lens for spectacles according to claim 1,
wherein the resin is an episulfide resin.

11. The lens for spectacles according to claim 1, further comprising:
at least one ultraviolet absorbing agent selected from a triazine-based ultraviolet absorbing agent or a benzotriazole-based ultraviolet absorbing agent.

12. Spectacles comprising:
the lens for spectacles according to claim 1.

13. A protective sheet comprising:
a support; and
a layer that is disposed on at least one surface of the support and contains a compound represented by Formula (1), 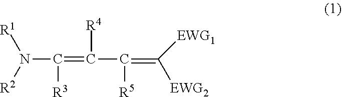
in Formula (1), EWG₁ and EWG₂ each independently represent a group having a Hammett's substituent constant σp value of 0.2 or more, R¹ and R² each independently represent an alkyl group, an aryl group, or a heteroaryl group, and R³, R⁴, and R⁵ each independently represent a hydrogen atom or a substituent.

14. The protective sheet according to claim 13,
wherein, in Formula (1), EWG₁ and EWG₂ each independently represent COOR⁶, SO₂R⁷, CN, or COR⁸, and R⁶, R⁷, and R⁸ each independently represent an alkyl group, an aryl group, or a heteroaryl group.

15. The protective sheet according to claim 13,
wherein, in Formula (1), EWG₁ and EWG₂ each independently represent COOR⁶, SO₂R⁷, CN, or COR⁸, R⁷ represents an aryl group, and R⁶ and R⁸ each independently represent an alkyl group.

16. The protective sheet according to claim 13,
wherein, in Formula (1), any one of EWG₁ or EWG₂ represents COOR⁶, and the other represents SO₂R⁷ or CN, R⁶ represents an alkyl group, and R⁷ represents an aryl group.

17. The protective sheet according to claim 13,
wherein, in Formula (1), R¹ and R² each independently represent an alkyl group.

18. The protective sheet according to claim 13,
wherein, in Formula (1), R³, R⁴, and R⁵ represent a hydrogen atom.

19. A display comprising:
the protective sheet according to claim 13.
